(19) United States
(12) Patent Application Publication
(10) Pub. No.: US 2023/0164241 A1
(43) Pub. Date: May 25, 2023

(54) FEDERATED MEC FRAMEWORK FOR AUTOMOTIVE SERVICES

(71) Applicant: Intel Corporation, Santa Clara, CA (US)

(72) Inventors: Miltiadis Filippou, München (DE); Dario Sabella, Gassino (IT)

(21) Appl. No.: 17/917,419

(22) PCT Filed: Dec. 22, 2020
(86) PCT No.: PCT/US2020/066710

§ 371 Date: Oct. 6, 2022

Related U.S. Application Data
(60) Provisional application No. 63/028,783, filed on May 22, 2020.

(51) Int. Cl. H04L 67/60; H04L 9/40

(52) U.S. Cl. CPC H04L 67/60; H04L 63/08

(57) ABSTRACT

A computing node to implement a federation management entity associated with a federated MEC network includes a NIC and processing circuitry coupled to the NIC. The processing circuitry is configured to detect a request for a MEC service, the request originating from a MEC application instantiated on a first MEC host within a first MEC system of the federated MEC network. A second MEC system of the federated MEC network is selected, which includes a second MEC host providing the MEC service. A set of common credentials for secure communication between the first and second MEC systems is determined. A response to the request is generated for communication to the first MEC system via the NIC. The response includes the set of common credentials and identification information of a MEC management entity in the second MEC system. The MEC management entity provides access to the MEC service.

This application claims the benefit of priority to U.S. Provisional Pat. Application Serial No. 63/028,783, filed May 22, 2020, which is incorporated herein by reference in its entirety.

### BACKGROUND

Edge computing, at a general level, refers to the implementation, coordination, and use of computing and resources at locations closer to the “edge” or collection of “edges” of the network. The purpose of this arrangement is to reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use cases that are projected to extensively utilize edge computing include connected self-driving cars, surveillance, Internet of Things (IoT) device data analytics, video encoding and analytics, location-aware services, device sensing in Smart Cities, among many other networks, and compute-intensive services.

Edge computing may, in some scenarios, offer node management services with orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network. Edge computing can also be used to help enhance communication between user devices or between loT devices.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing;

FIG. 2 illustrates operational layers among endpoints, an edge cloud, and cloud computing environments;

FIG. 3 illustrates an example approach for networking and services in an edge computing system;

FIG. 4 illustrates deployment of a virtual edge configuration in an edge computing system operated among multiple edge nodes and multiple tenants;

FIG. 5 illustrates various compute arrangements deploying containers in an edge computing system;

FIG. 6 illustrates a compute and communication use case involving mobile access to applications in an edge computing system;

FIG. 7A provides an overview of example components for compute deployed at a compute node in an edge computing system;

FIG. 7B provides a further overview of example components within a computing device in an edge computing system;

FIG. 7C illustrates a software distribution platform, according to some embodiments;

FIG. 8A illustrates a MEC network architecture supporting federation management, according to an example embodiment;

FIG. 8B illustrates a MEC reference architecture in a Network Function Virtualization (NFV) environment, according to an example embodiment;

FIG. 9 illustrates a 3GPP-based 5G system architecture and an example of the mapping of MEC entities to some of the 5G system’s components (namely, AF and UPF), according to an example embodiment;

FIG. 10 illustrates a V2X multi-stakeholder scenario which can be used in connection with federated management functions, according to an example embodiment;

FIG. 11 illustrates a MEC federation reference scenario for a multi-OEM vehicle use case where both MNOs have MEC platforms with instantiated MEC application Y (“MEC App Y”), according to an example embodiment;

FIG. 12 illustrates an exemplary MEC system deployment scenario per ETSI MEC reference architecture including a service layer which can be used in connection with federated management functions, according to an example embodiment;

FIG. 13 illustrates a high-level GSMA operator platform, according to an example embodiment;

FIG. 14 illustrates hierarchical functional levels based on which a MEC federation can be formed, according to an example embodiment;

FIG. 15 illustrates service consumption options within a single MEC system, according to an example embodiment;

FIG. 16 illustrates a MEC federation scenario enabling edge service consumption across MEC systems, according to an example embodiment;

FIG. 17 illustrates a MEC federation scenario including communication between two MEC platforms belonging to two MEC systems of a MEC federation using an Mpp-fed reference point, according to an example embodiment;

FIG. 18 illustrates a MEC federation scenario including communication using an Mfm-fed federation management reference point connecting a MEC system Mobile Edge Orchestrator (MEO) with a federation manager present in each MEC system, according to an example embodiment;

FIG. 19 illustrates a MEC federation scenario including communication using an Mfm-fed federation management reference point connecting a MEC system MEO with a common federation manager associated with multiple MEC systems, according to an example embodiment;

FIG. 20 is a message sequence chart between multiple federation managers and MEOs in a federated MEC network, according to an example embodiment;

FIG. 21 illustrates a MEC federation scenario including communication using a Meo-fed federation management reference point connecting MEOs in a federated MEC network, according to an example embodiment;

FIG. 22 illustrates a sequence diagram of signaling for establishing hierarchical inter-MEC system communication for service consumption in a federated MEC network, according to an example embodiment;

FIG. 23 illustrates MEC federation reference points in a federated MEC network using a separate federation manager per MEC system, according to an example embodiment;

FIG. 24 illustrates MEC federation reference points in a federated MEC network using a single federation manager, according to an example embodiment; and

FIG. 25 illustrates a flowchart of a method for implementing a federation management entity in a federated MEC network, according to an example embodiment.

### DETAILED DESCRIPTION

The following embodiments generally relate to a hierarchical signaling framework configured to implement a Multi-Access Edge Computing (MEC) federation constituting of MEC systems which can be operated by different parties (e.g., mobile network operators, or MNOs). The signaling framework refers to the following hierarchical inter-MEC system communication levels: (a) MEC system (i.e., below business level) discovery, including security (authentication/ authorization, system topology hiding/encryption), charging, identity management, and monitoring aspects as an essential prerequisite to forming a MEC federation; (b) MEC platform discovery, either at high granularity (i.e., at MEC platform level) or at low granularity (e.g., at zone, zone group, network function virtualization instance (NFVI) Point-of-Presence, and NFVI node if a needed service is deployed as a VNF); and (d) Information exchange at MEC platform level, for the needs of MEC service consumption, or MEC app-to-app communication. The disclosed techniques may be used to facilitate the establishment of MEC applications and adoption from stakeholders in interoperable scenarios. Such a development will enable and support new business and market opportunities with regards to MEC and cloud computing technology, such as data centers. More particularly, the proposed signaling framework can be used to address the MNOs′ needs to form MEC system federations aiming to enhance service performance (e.g., V2X service continuity in automotive communication scenarios or other communication scenarios).

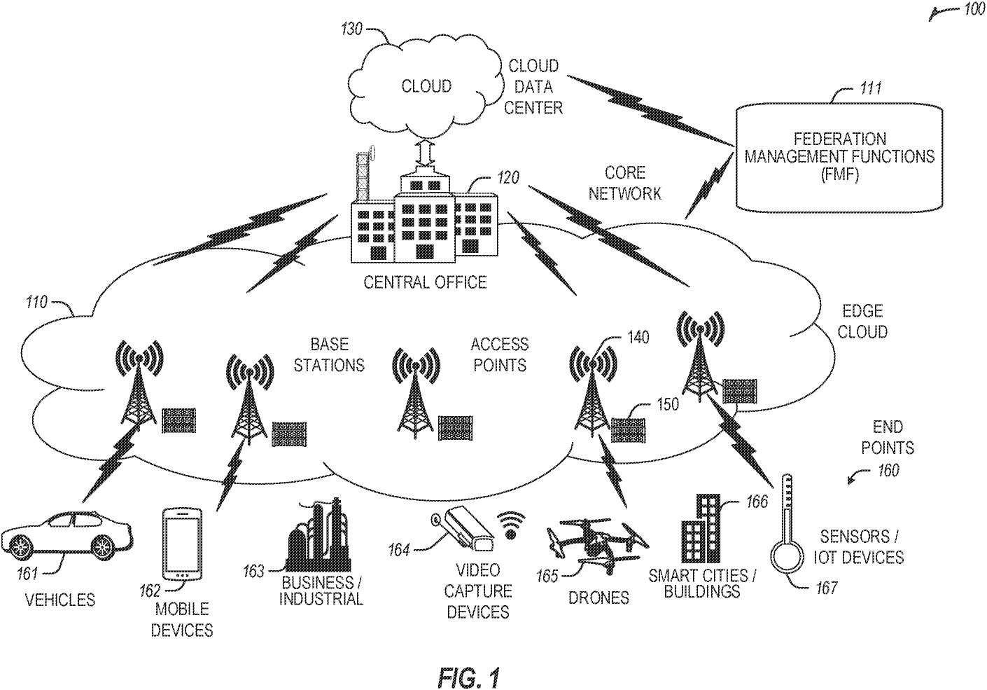

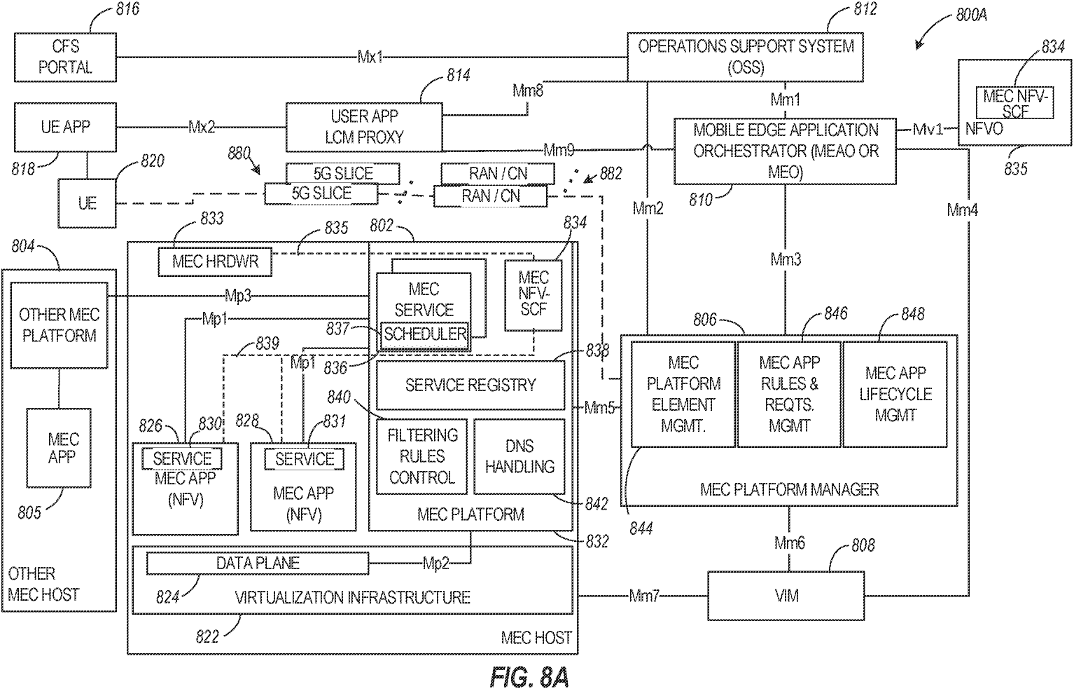

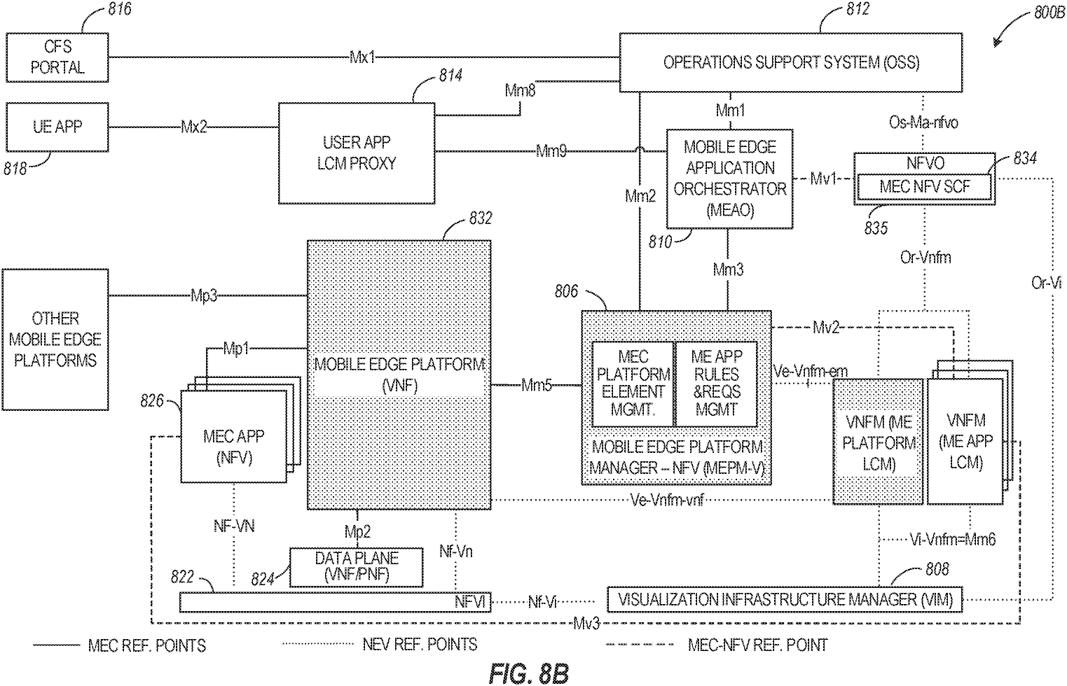

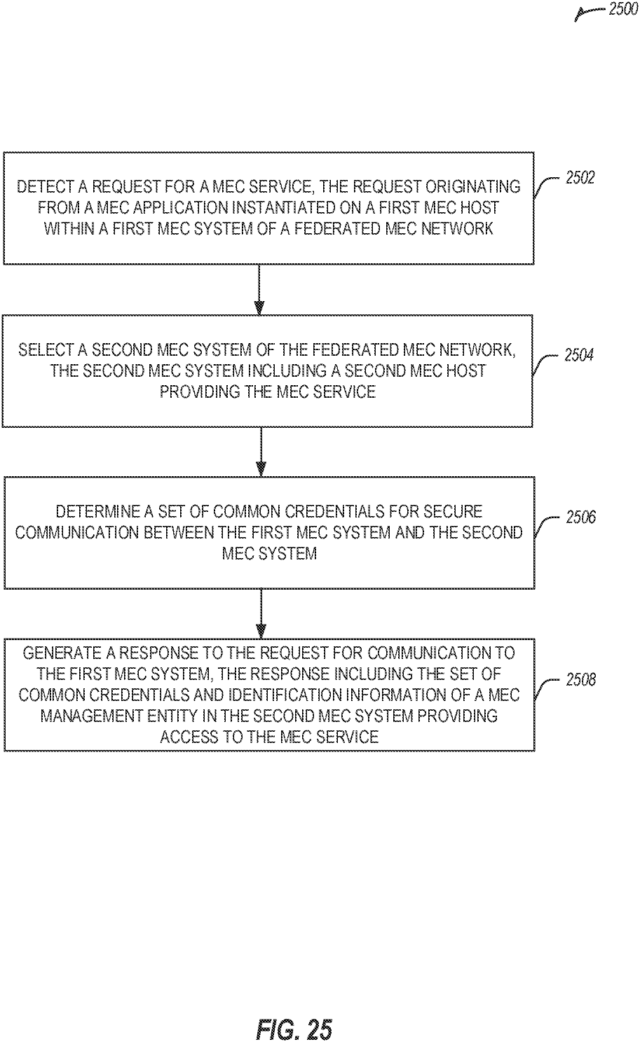

Systems according to embodiments extend the concepts of Named-Data-Networks (NDNs) and Information Centric Networks (ICNs) by providing computing and storage services that can be registered, discovered, and accessed in a way similar to how cached content is accessed in NDNs and ICNs. End nodes can operate in a default mode of operation that can be extended dynamically to take advantage of additional services offered by edge nodes when communicating with peer devices. Besides enhancing end devices capabilities in a P2P exchange, or any additional exchange, such capabilities could incite edge network providers, communication service providers, or cloud service providers, to propose significant compute/caching/storage capabilities at the edges for these end nodes to use them as part of their processing path. Example embodiments can be implemented in systems similar to those shown in any of the systems described below in reference to FIGS. 1-7C. Additional description of federated MEC frameworks in connection with an edge architecture and edge computing devices is provided hereinbelow in connection with at least FIG. 8A - FIG. 25.

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power are often constrained. Thus, edge computing attempts to reduce the number of resources needed for network services, through the distribution of more resources that are located closer to both geographically and in-network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their infrastructures. These include a variety of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use cases (e.g., autonomous driving or video surveillance) for connected client devices. Or as an example, base stations may be augmented with compute and acceleration resources to directly process service workloads for the connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In some aspects, the edge cloud 110 and the cloud data center 130 can be configured with federation management functions (FMF) 111. As used herein, the term “federation management functions” includes one or more of the following functionalities: (1) configure a computing node or a network function virtualization instance as a federation manager, Mobile Edge Orchestrator (MEO), or federation broker to manage multiple federation managers; (2) establish and manage the following hierarchical inter-MEC system communication levels: (a) MEC system (i.e., below business level) discovery, including security (authentication/ authorization, system topology hiding/ encryption), charging, identity management, and monitoring aspects as an essential prerequisite to form a MEC federation; (b) MEC platform discovery, either at high granularity (i.e., at MEC platform level) or at low granularity (e.g., at zone, zone group, network function virtualization instance (NFVI) Point-of-Presence, and NFVI node if a needed service is deployed as a VNF); and (d) Information exchange at MEC platform level, for the needs of MEC service consumption, or for MEC app-to-app communication; (3) configure the use of a federation management reference point Mfm-fed for communications between a federation manager (including a common federation manager for at least two MEC systems) and a MEO; (4) configure the use of a federation management reference points Meo-fed for communications between two MEOs; and (5) configure the use of a federation management reference points Mpp-fed for communications between two MEC platforms.

In some embodiments, network management entities within the edge cloud 110 and the cloud data center 130 can be configured with a federation manager (or another management entity) performing the FMF 111 to facilitate exchanges between MEC systems and improve inter- and intra-MEC system communications (e.g., associated with mobile devices in V2X communications) within a federated network environment. In some embodiments, the federated network environment is formed by a federation of multiple MEC systems, and communication between such systems is managed by a federation manager. Each of the MEC systems can include its federation manager, and inter-MEC system communication can be facilitated by a federation broker configured to manage the federation managers of the MEC systems. Additional functionalities and techniques associated with the FMF 111 are discussed in connection with FIG. 8A - FIG. 25.

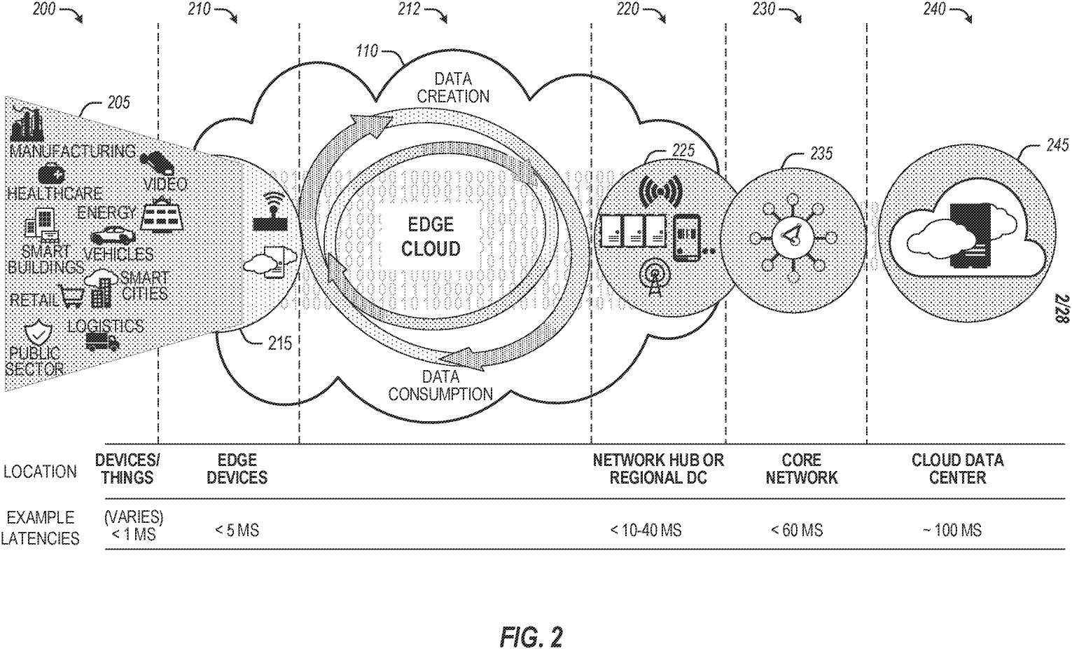

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted. Any of the communication use cases 205 can be configured based on FMF 111, which may be performed by a communication node configured as a federation manager (or another federation management entity) within a federated MEC network as discussed in connection with FIG. 8A - FIG. 25.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, a number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of (a) Priority (throughput or latency; also referred to as service level objective or SLO) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, whereas some other input streams may tolerate an occasional failure, depending on the application); and (c) Physical constraints (e.g., power, cooling, and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real-time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource-constrained and therefore there is pressure on the usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permission access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from the client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, the cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” that connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

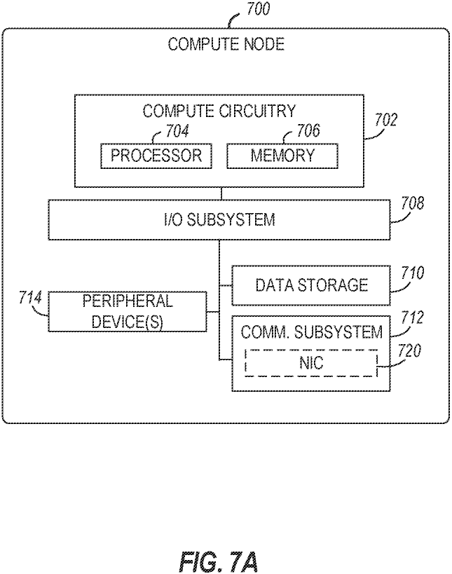

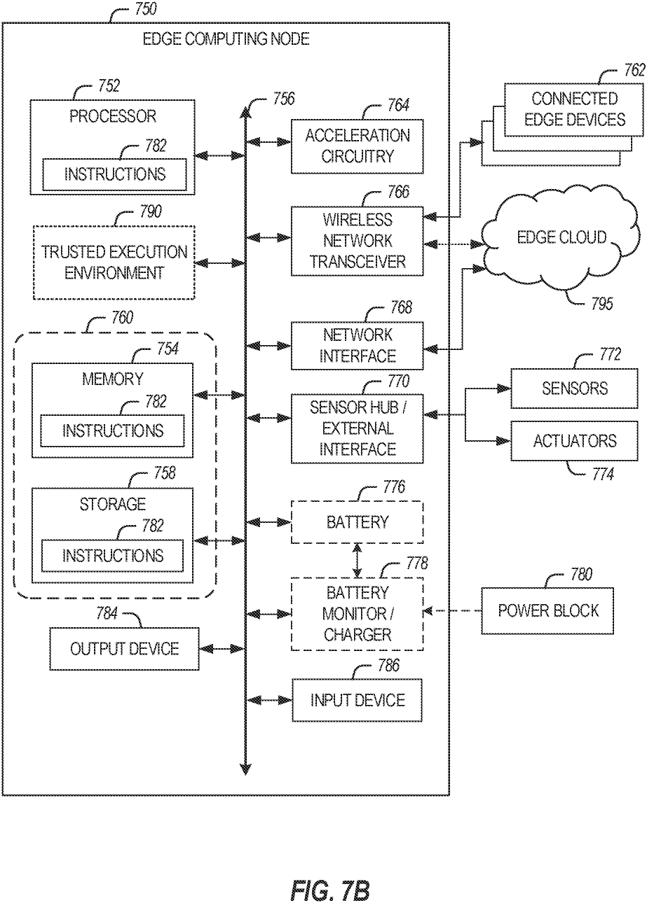

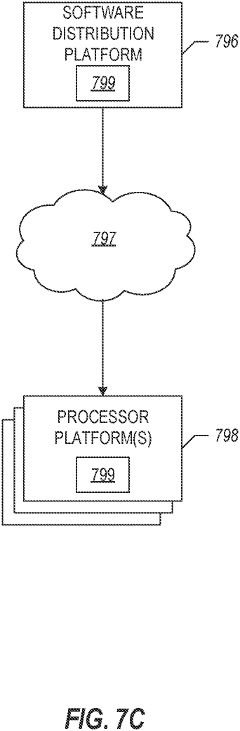

The network components of the edge cloud 110 may be servers, multi-tenant servers, appliance computing devices, and/or any other type of computing device. For example, the edge cloud 110 may include an appliance computing device that is a self-contained electronic device including a housing, a chassis, a case, or a shell In some circumstances, the housing may be dimensioned for portability such that it can be carried by a human and/or shipped. Example housings may include materials that form one or more exterior surfaces that partially or fully protect the contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein, and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent of other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 7A-7B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code, or scripts may execute while being isolated from one or more other applications, software, code, or scripts.

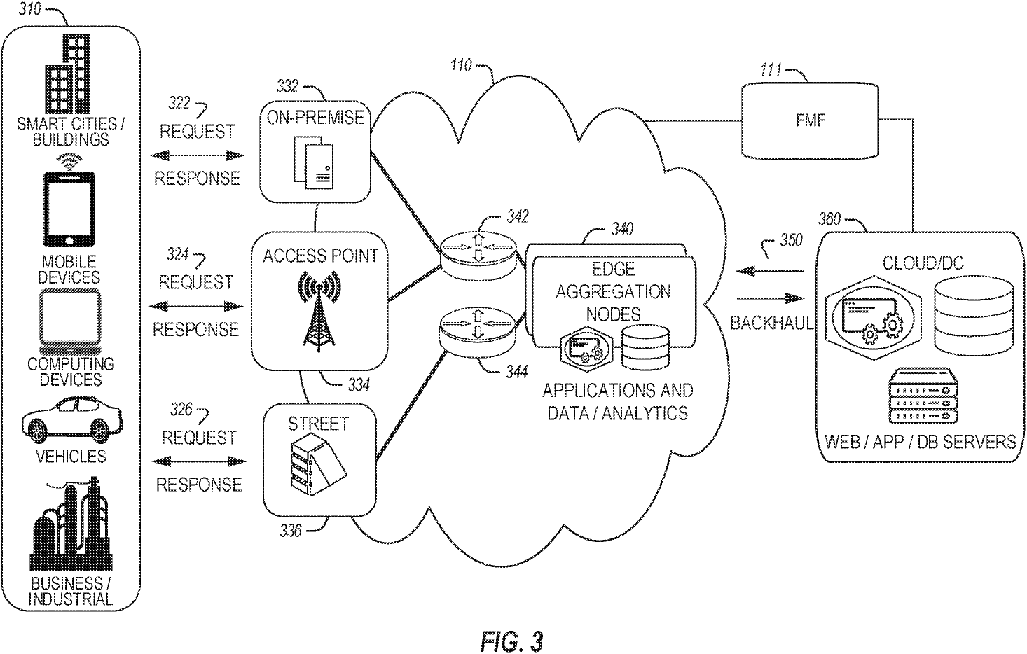

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure. In an example embodiment, the edge cloud 110 and the cloud or data center 360 utilize FMF 111 in connection with disclosed techniques. The FMF 111 may be performed by a communication node configured as a federation manager (or another federation management entity) within a federated MEC network as discussed in connection with FIG. 8A - FIG. 25.

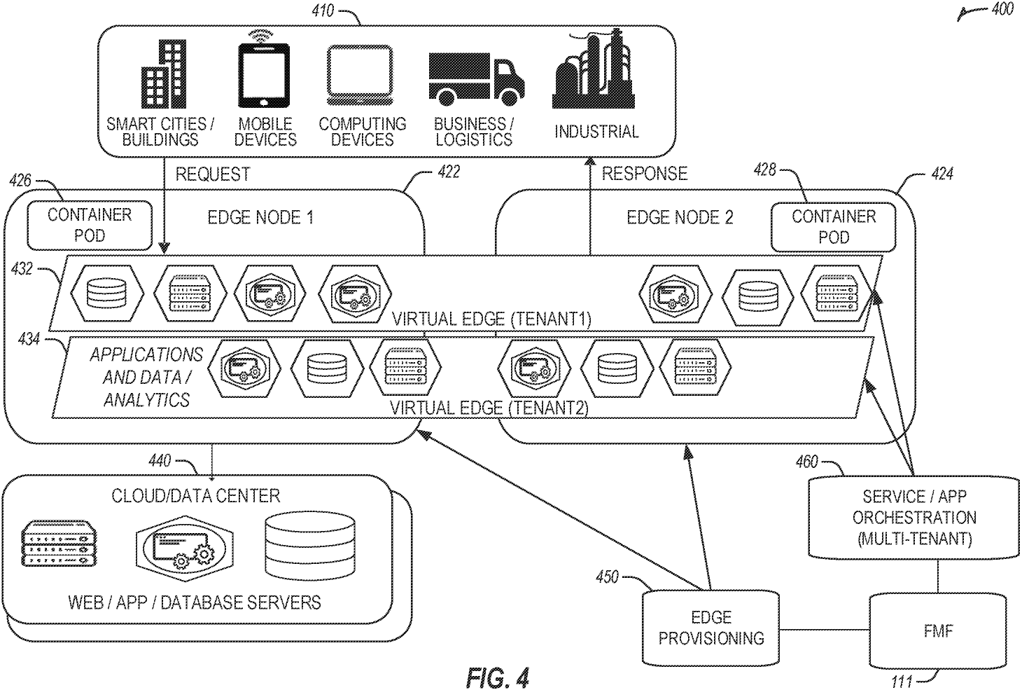

FIG. 4 illustrates deployment and orchestration for virtual edge configurations across an edge computing system operated among multiple edge nodes and multiple tenants. Specifically, FIG. 4 depicts the coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 (or virtual edges) provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers the first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460. In an example embodiment, the edge provisioning functions 450 and the orchestration functions 460 can utilize FMF 111 in connection with disclosed techniques. The FMF 111 may be performed by a communication node configured as a federation manager (or another federation management entity) within a federated MEC network as discussed in connection with FIG. 8A - FIG. 25.

It should be understood that some of the devices in the various client endpoints 410 are multi-tenant devices where Tenant 1 may function within a tenant1 ‘slice’ while Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant-specific RoT. An RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in virtual edge instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshaling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain an RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support an RoT context for each. Accordingly, the respective RoTs spanning devices in 410, 422, and 440 may coordinate the establishment of a distributed trusted computing base (DTCB) such that a tenant-specific virtual trusted secure channel linking all elements end to end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency-sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edges 432, 434 are partitioned according to the needs of each container.

With the use of container pods, a pod controller oversees the partitioning and allocation of containers and resources. The pod controller receives instructions from an orchestrator (e.g., performing orchestration functions 460) that instructs the controller on how best to partition physical resources and for what duration, such as by receiving key performance indicator (KPI) targets based on SLA contracts. The pod controller determines which container requires which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents the assignment of resources until the right tenant authenticates or prevents provisioning of data or a workload to a container until an attestation result is satisfied.

Also, with the use of container pods, tenant boundaries can still exist but in the context of each pod of containers. If each tenant-specific pod has a tenant-specific pod controller, there will be a shared pod controller that consolidates resource allocation requests to avoid typical resource starvation situations. Further controls may be provided to ensure the attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked before the second pod executing.

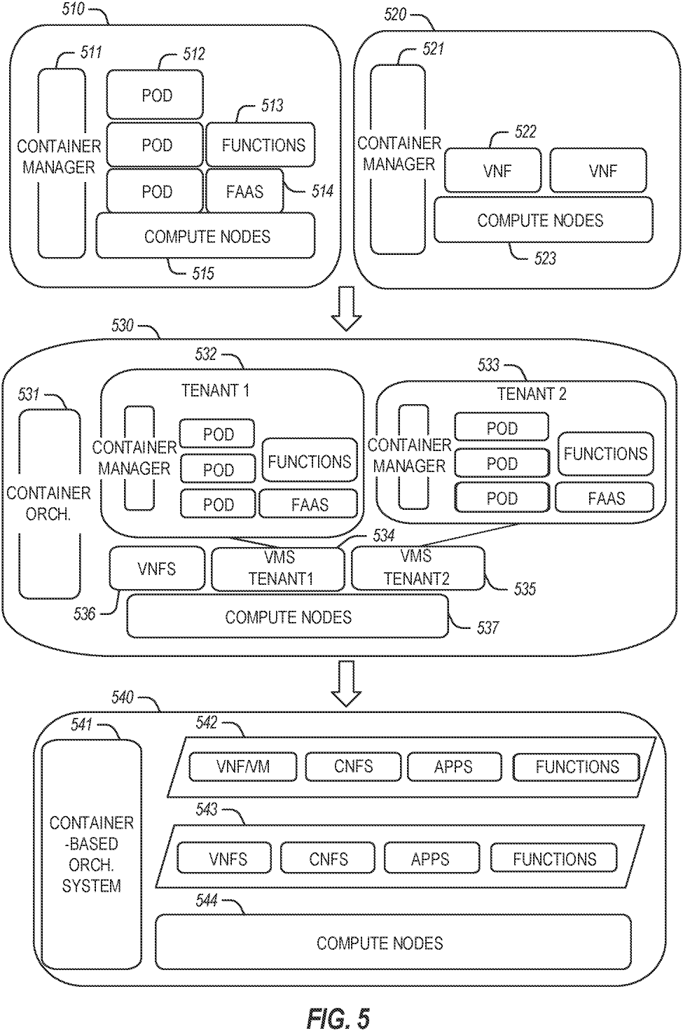

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions and functions-as-a-service instances through execution via compute nodes (515 in arrangement 510) or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside from the execution of virtualized network functions). This arrangement is further adapted for use in system arrangement 540, which provides containers 542, 543, or execution of the various functions, applications, and functions on compute nodes 544, as coordinated by a container-based orchestration system 541.

The system arrangements depicted in FIG. 5 provide an architecture that treats VMs, Containers, and Functions equally in terms of application composition (and resulting applications are combinations of these three ingredients). Each ingredient may involve the use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves, and hardware partitioning schemes may be used by edge owners to enforce tenancy. Other isolation environments may include bare metal (dedicated) equipment, virtual machines, containers, virtual machines on containers, or combinations thereof.

In further examples, aspects of software-defined or controlled silicon hardware, and other configurable hardware, may integrate with the applications, functions, and services of an edge computing system. Software-defined silicon may be used to ensure the ability for some resource or hardware ingredient to fulfill a contract or service level agreement, based on the ingredient’s ability to remediate a portion of itself or the workload (eg., by an upgrade, reconfiguration, or provision of new features within the hardware configuration itself).

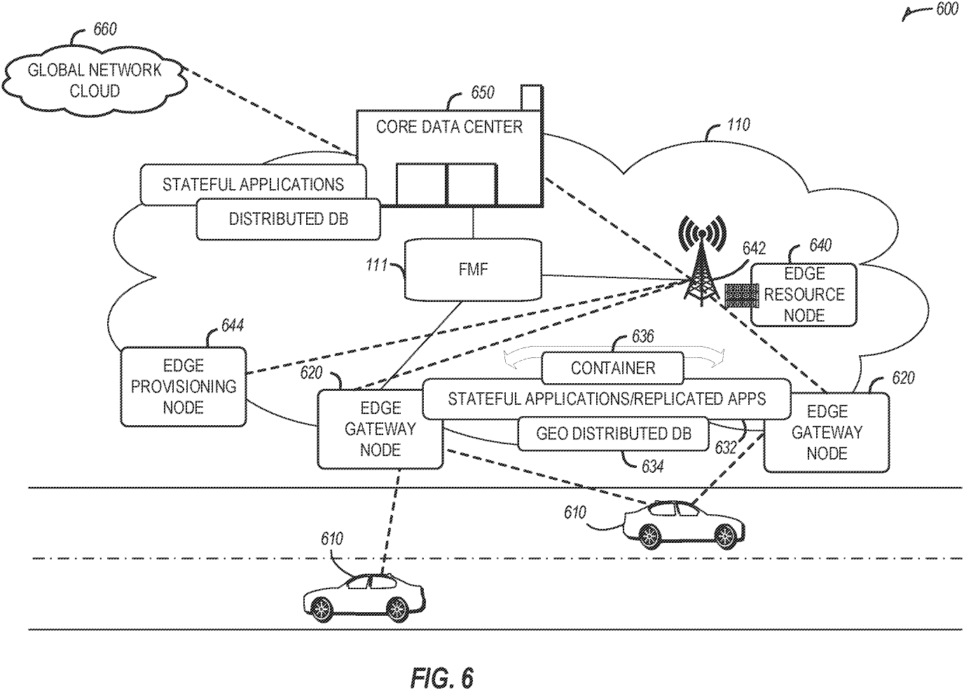

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles that communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate to maintain a consistent connection and context for the client compute node 610. Likewise, mobile edge nodes may aggregate at the high priority services or according to the throughput or latency resolution requirements for the underlying service(s) (e.g., in the case of drones) The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances, or components located at or in a communication base station 642 (e.g., a base station of a cellular network) As discussed above, the respective edge resource nodes 640 include an amount of processing and storage capabilities, and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location, or latency, work may continue on edge resource nodes when the processing priorities change during the processing activity. Likewise, configurable systems or hardware resources themselves can be activated (e.g, through a local orchestrator) to provide additional resources to meet the new demand (e.g., adapt the compute resources to the workload data)

The edge resource node(s) 640 also communicates with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or a pod of containers) may be flexibly migrated from an edge node 620 to other edge nodes (e.g., 620, 640, etc.) such that the container with an application and workload does not need to be reconstituted, re-compiled, re-interpreted for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container-native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In an example embodiment, the edge cloud 110 in FIG. 6 utilizes FMF 111 in connection with disclosed techniques. The FMF 111 may be performed by a communication node configured as a federation manager (or another federation management entity) within a federated MEC network as discussed in connection with FIG. 8A - FIG. 25.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application that may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer-readable (also referred to as machine-readable) instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer-readable instructions 782 of FIG. 7B. The receiving parties may be consumers, service providers, users, retailers, OEMs, etc., who purchase and/or license the software instructions for use and/or re-sale and/or sub-licensing.

In an example, the edge provisioning node 644 includes one or more servers and one or more storage devices. The storage devices host computer-readable instructions such as the example computer-readable instructions 782 of FIG. 7B, as described below. Similar to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer-readable instructions 782 from the edge provisioning node 644. For example, the software instructions, which may correspond to the example computer-readable instructions 782 of FIG. 7B may be downloaded to the example processor platform/s, which is to execute the computer-readable instructions 782 to implement the methods described herein.

In some examples, the processor platform(s) that execute the computer-readable instructions 782 can be physically located in different geographic locations, legal jurisdictions, etc. In some examples, one or more servers of the edge provisioning node 644 periodically offer, transmit, and/or force updates to the software instructions (e.g., the example computer-readable instructions 782 of FIG. 7B) to ensure improvements, patches, updates, etc. are distributed and applied to the software instructions implemented at the end-user devices. In some examples, different components of the computer-readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edges, networking, or endpoint components. For example, an edge compute device may be embodied as a personal computer, a server, a smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application-specific integrated circuit (ASIC), reconfigurable hardware or hardware circuitry, or other specialized hardware to facilitate the performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within a SOC or integrated with networking circuitry (e.g., in a SmartNIC, or enhanced SmartNIC), acceleration circuitry, storage devices, or AI hardware (e.g., GPUs, programmed FPGAs, Network Processing Units (NPUs), Infrastructure Processing Units (IPUs), Storage Processing Units (SPUs), AI Processors (APUs), Data Processing Unit (DPUs), or other specialized accelerators such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that an xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte-addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable crosspoint architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of device configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (eg., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, California. As an example, the processor 752 may include an Intel® Architecture Core™ based CPU processor, such as a Quark™, an Atom™, an i3, an i5, an i7, an i9, or an MCU-class processor, or another such processor available from Intel®. However, any number of other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As an example, the memory 754 may be random access memory (RAM) per a Joint Electron Devices Engineering Council (JEDEC) design such as the DDR or mobile DDR standards (e.g., LPDDR, LPDDR2, LPDDR3, or LPDDR4) In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 758 may also couple to the processor 752 via the interconnect 756. In an example, storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry-standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications under the Institute of Electrical and Electronics Engineers (IEEE) 802.11 standard. Also, wireless wide area communications, e.g, according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4 g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service, or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium-ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application-specific integrated circuit (ASIC).

Also in a specific example, the instructions 782 on the processor 752 (separately, or in combination with the instructions 782 of the machine-readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through the use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in device 750 through the TEE 790 and the processor 752.

In an example, the instructions 782 provided via memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium”, “computer-readable medium”, “machine-readable storage”, and “computer-readable storage” are interchangeable.

In further examples, a machine-readable medium also includes any tangible medium that is capable of storing, encoding, or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of several transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

FIG. 7C illustrates an example software distribution platform 796 to distribute software, such as the example computer-readable instructions 799, to one or more devices, such as processor platform(s) 798 and/or example connected edge devices 762 of FIG. 7B. The example software distribution platform 796 may be implemented by any computer server, data facility, cloud service, etc., capable of storing and transmitting software to other computing devices (e.g., third parties, the example connected edge devices 762 of FIG. 7B). Example connected edge devices may be customers, clients, managing devices (e.g., servers), third parties (e.g., customers of an entity owning and/or operating the software distribution platform 796). Example connected edge devices may operate in commercial and/or home automation environments. In some examples, a third party is a developer, a seller, and/or a licensor of software such as the example computer-readable instructions 799. The third parties may be consumers, users, retailers, OEMs, etc. that purchase and/or license the software for use and/or re-sale and/or sub-licensing. In some examples, distributed software causes the display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc).

In the illustrated example of FIG. 7C, the software distribution platform 796 includes one or more servers and one or more storage devices. The storage devices store the computer-readable instructions 799, which may correspond to the example computer-readable instructions 782 of FIG. 7B, as described above. The one or more servers of the example software distribution platform 796 are in communication with a network 797, which may correspond to any one or more of the Internet and/or any of the example networks described herein. In some examples, the one or more servers are responsive to requests to transmit the software to a requesting party as part of a commercial transaction. Payment for the delivery, sale, and/or license of the software may be handled by the one or more servers of the software distribution platform and/or via a third-party payment entity. The servers enable purchasers and/or licensors to download the computer-readable instructions 799 from the software distribution platform 796. For example, the software, which may correspond to the example computer-readable instructions 782 of FIG. 7B, may be downloaded to the example processor platform(s) 798 (e.g., example connected edge devices), which is/are to execute the computer-readable instructions 799 to implement the techniques discussed herein. In some examples, one or more servers of the software distribution platform 796 are communicatively connected to one or more security domains and/or security devices through which requests and transmissions of the example computer-readable instructions 799 must pass. In some examples, one or more servers of the software distribution platform 796 periodically offer, transmit, and/or force updates to the software (e.g., the example computer-readable instructions 782 of FIG. 7B which can be the same as the computer-readable instructions 799) to ensure improvements, patches, updates, etc. are distributed and applied to the software at the end-user devices.

In the illustrated example of FIG. 7C, the computer-readable instructions 799 are stored on storage devices of the software distribution platform 796 in a particular format. A format of computer-readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer-readable instructions 799 stored in the software distribution platform 796 are in a first format when transmitted to the example processor platform(s) 796. In some examples, the first format is an executable binary in which particular types of the processor platform(s) 798 can execute. However, in some examples, the first format is uncompiled code that requires one or more preparation tasks to transform the first format to a second format to enable execution on the example processor platform(s) 798. For instance, the receiving processor platform(s) 798 may need to compile the computer-readable instructions 799 in the first format to generate executable code in a second format that is capable of being executed on the processor platform(s) 798. In still other examples, the first format is interpreted code that, upon reaching the processor platform(s) 798, is interpreted by an interpreter to facilitate execution of instructions.

FIG. 8A illustrates a MEC network architecture 800A supporting federation management, according to an example embodiment. FIG. 8A specifically illustrates a MEC architecture 800A with MEC hosts 802 and 804 providing functionalities per one or more ETSI MEC specifications (e.g., ETSI GS MEC-003 and ETSI GR MEC-024 specifications). Specifically, enhancements to the MEO 810 can be used for providing federation management functions within the MEC network architecture 800A.

Referring to FIG. 8A, the MEC network architecture 800A includes MEC hosts 802 and 804, a virtualization infrastructure manager (VIM) 808, a MEC platform manager 806, a Mobile Edge Application Orchestrator (MEAO) (also referred to as a MEC orchestrator or MEO) 810, an operations support system (OSS) 812, a user app proxy 814, a UE app 818 running on LTE 820, and CFS portal 816. The MEC host 802 can include a MEC platform 832 with filtering rules control module 840, a DNS handling module 842, service registry 838, and MEC services 836. The MEC host 804 can include resources used to instantiate MEC apps 805. The MEC services 836 can include at least one scheduler 837, which can be used to select resources for instantiating MEC apps (or NFVs) 826 and 828 upon virtualization infrastructure 822 that includes a data plane 824. The MEC apps 826 and 828 can be configured to provide services 830/831, which can include processing network communications traffic of different types associated with one or more wireless connections.

The MEC platform manager 806 can include MEC platform element management module 844, MEC app rules and requirements management module 846, and a MEC app lifecycle management module 848.

In some aspects, UE 820 can be configured to communicate to one or more of the core networks 882 via one or more of the network slice instances (NSIs) 880. In some aspects, the core networks 882 can use slice management functions to dynamically configure NSIs 880, including dynamically assign a slice to a UE, configure network functions associated with the slice, configure a MEC app for communicating data using the slice, reassign a slice to a UE, dynamically allocate or reallocate resources used by one or more of the NSIs 880, or other slice related management functions. One or more of the functions performed in connection with slice management can be initiated based on user requests (e.g., via a UE), based on a request by a service provider, or maybe triggered automatically in connection with an existing Service Level Agreement (SLA) specifying slice-related performance objectives. In some aspects, the slice management functions in connection with NSIs 880 can be facilitated by E2E multi-slice support functions for MEC-enabled 5G deployments, provided by the MEC NFV-SCF 434 within the MEC host 802, the MEC platform manager 806, or within another MEC entity.

FIG. 8B illustrates a MEC reference architecture 800B in a Network Function Virtualization (NFV) environment, according to an example. The MEC architecture 800B can be configured to provide functionalities according to an ETSI MEC specification, such as the ETSI GR MEC-017 specification.

In some aspects, ETSI MEC can be deployed in an NFV environment as illustrated in FIG. 8B which can also utilize federation management functions. In some aspects, the MEC platform is deployed as a virtualized network function (VNF). The MEC applications can appear like VNFs towards the ETSI NFV Management and Orchestration (MANO) components (e.g., VIM 808, MEAO 810, and NFVO 835). This allows the reuse of ETSI NFV MANO functionality. In some aspects, the full set of MANO functionality may be unused and certain additional functionality may be needed. Such a specific MEC application is denoted by the name “MEC app VNF” (or ME app VNF) as discussed herein. In some aspects, the virtualization infrastructure is deployed as an NFVI and its virtualized resources are managed by the virtualized infrastructure manager (VIM). For that purpose, one or more of the procedures defined by ETSI NFV Infrastructure specifications, i.e. ETSI GS NFV-INF 003, ETSI GS NFV-INF 004, and ETSI GS NFV-INF 005 can be used.

In some aspects, the MEC application (or app) VNFs will be managed like individual VNFs, allowing that a MEC-in-NFV deployment can delegate certain orchestration and Life Cycle Management (LCM) tasks to the NFVO and VNFM functional blocks, as defined by ETSI NFV MANO.

In some aspects, the Mobile Edge Platform Manager (MEPM) 806 can be transformed into a “Mobile Edge Platform Manager - NFV” (MEPM-V) that delegates the LCM part to one or more virtual network function manager(s) (VNFM(s)). The Mobile Edge Orchestrator (MEO), as defined in the MEC reference architecture ETSI GS MEC-003, can be transformed into a “Mobile Edge Application Orchestrator” (MEAO) 810 that uses the NFVO 835 for resource orchestration, and orchestration of the set of MEC app VNFs as one or more NFV Network Services (NSs). In some embodiments, the MEAO 810 and the MEPM 806 can be configured to perform federation management functions, including communication between MEC systems in a federated MEC network.

In some aspects, the Mobile Edge Platform VNF, the MEPM-V, and the VNFM (ME platform LCM) can be deployed as a single package as per the ensemble concept in 3GPP TR 32.842, or that the VNFM is a Generic VNFM as per ETSI GS NFV-IFA 009 and the Mobile Edge Platform VNF and the MEPM-V are provided by a single vendor.

In some aspects, the Mp1 reference point between a MEC application and the ME platform can be optional for the MEC application, unless it is an application that provides and/or consumes a ME service. Various MEC-related interfaces and reference points discussed herein are further defined in the following ETSI-related technical specifications: ETSI GS MEC-003 and ETSI GR MEC-024 specifications.

The Mp1 reference point is a reference point between the mobile edge platform and the mobile edge applications. The Mp1 reference point provides service registration, service discovery, and communication support for services. It also provides other functionality such as application availability, session state relocation support procedures, traffic rules, and DNS rules activation, access to persistent storage and time of day information, etc. This reference point can be used for consuming and providing service-specific functionality.

The Mp2 reference point is a reference point between the mobile edge platform and the data plane of the virtualization infrastructure. The Mp2 reference point is used to instruct the data plane on how to route traffic among applications, networks, services, etc.

The Mp3 reference point is a reference point between mobile edge platforms and it is used for control communication between mobile edge platforms.

In some aspects, the Mm3 reference point between the MEAO 810 and the MEPM-V 806 is based on the Mm3 reference point, as defined by ETSI GS MEC-003. Changes may be configured to this reference point to cater to the split between MEPM-V and VNFM (MEC applications LCM).

In some aspects, the following new reference points (Mv1, Mv2, and Mv3) are introduced between elements of the ETSI MEC architecture and the ETSI NFV architecture to support the management of MEC app VNFs. The following reference points are related to existing NFV reference points, but only a subset of the functionality may be used for ETSI MEC, and extensions may be necessary: Mv1 (this reference point connects the MEAO and the NFVO; it is related to the Os-Ma-nfvo reference point, as defined in ETSI NFV); Mv2 (this reference point connects the VNF Manager that performs the LCM of the MEC app VNFs with the MEPM-V to allow LCM related notifications to be exchanged between these entities; it is related to the Ve-Vnfm-em reference point as defined in ETSI NFV, but may include additions, and might not use all functionality offered by Ve-Vnfm-em); Mv3 (this reference point connects the VNF Manager with the MEC app VNF instance, to allow the exchange of messages e.g. related to MEC application LCM or initial deployment-specific configuration; it is related to the Ve-Vnfm-vnf reference point, as defined in ETSI NFV, but may include additions, and might not use all functionality offered by Ve-Vnfm-vnf.

In some aspects, the following reference points are used as they are defined by ETSI NFV: Nf-Vn (this reference point connects each MEC app VNF with the NFVI); Nf-Vi (this reference point connects the NFVI and the VIM); Os-Ma-nfvo (this reference point connects the OSS and the NFVO. It is primarily used to manage NSs, i.e several VNFs connected and orchestrated to deliver a service); Or-Vnfm (this reference point connects the NFVO and the VNFM; it is primarily used for the NFVO to invoke VNF LCM operations); Vi-Vnfm (this reference point connects the VIM and the VNFM; it is primarily used by the VNFM to invoke resource management operations to manage the cloud resources that are needed by the VNF; it is assumed in an NFV-based MEC deployment that this reference point corresponds 1:1 to Mm6); and Or-Vi (this reference point connects the NFVO and the VIM; it is primarily used by the NFVO to manage cloud resources capacity).

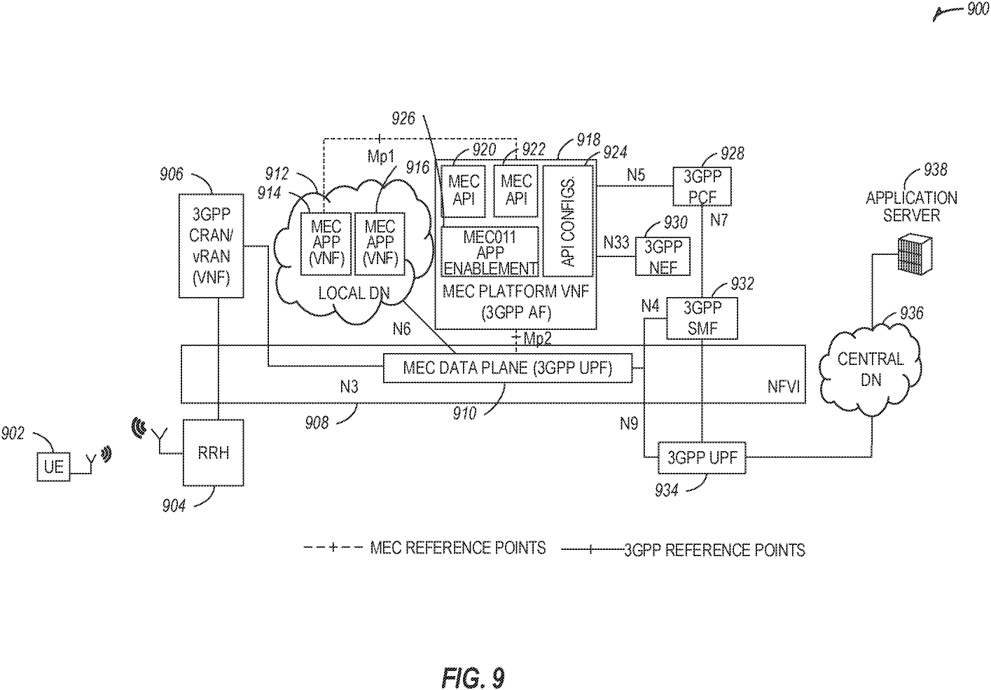

FIG. 9 illustrates a MEC-enabled 5G communication system 900 and an example of the mapping of MEC entities to some of the 5G system’s components (namely, AF and UPF), according to an example. The MEC-enabled 5G communication system 900 can be configured to provide federation management functions as well as functionalities per one or more ETSI MEC specifications, such as the ETSI GS MEC-003 specification, the ETSI GR MEC-017 specification, and/or the ETSI GS MEC-024 specification.

The mapping of MEC entities into a 5G system is depicted in FIG. 9. In particular: a MEC platform is implemented as a particular application function (AF) in 3GPP; the Data Plane in the MEC architecture corresponds to a User Plane Function (UPF) in 3GPP, and the MEC apps are mapped to the local DN (Data Network) in 3GPP.

As illustrated in FIG. 9, UE 902 is coupled to RAN 906 via a remote radio head (RRH) 904. The RAN 906 communicates with a MEC data plane 910 within NFVI 908. The MEC data plane 910 within the NFVI 908 is coupled to a local data network 912 of the MEC platform 918 via an N6 reference point. The MEC platform 918 is coupled to the local data network 912 via a MEC reference point Mp1. The MEC platform 918 may be instantiated as a VNF and may include MEC APIs 920 and 922 for communication with MEC apps 914 and 916 instantiated as a VNFs within the local data network 912. The MEC platform 918 may further include API configuration information 924 (e.g., as provided by the ETSI MEC-009 specification) and application enablement functions 926 (e.g., as provided by the ETSI MEC-011 specification). The MEC platform 918 is coupled to 3GPP network functions such as NEF 930, PCF 928, SMF 932, and UPF 934. The MEC data plane 910 is coupled to the 3GPP network functions SMF 932 and the UPF 934. Both the MEC platform 918 and the MEC data plane 910 are coupled to the central data network 936 and the application server 938 via the UPF 934.

In some aspects, the RAN 906 may be fully virtualized (e.g., as a VNF using resources of the MEC system). For In some aspects, the MEC-enabled 5G communication system 900 may use a MEC NFV-SCF to provide E2E multi-slice support, including generating and implementing one or more slice configuration policies based on utility function modeling and evaluation of latency or other characteristics of MEC and non-MEC communication links for a given NSI configured within a MEC-enabled 5G communication network. For example, a QoS flow of the UE 902 may be associated with a network slice instance which includes a virtual RAN 906, the MEC data plane 910 functioning as a 5G UPF network function, a MEC app such as 914 within the local data network 912, and the MEC platform VNF 918 functioning as a 5G AF network function. In this regard, a specific NSI associated with a QoS of the UE 902 includes non-MEC reference points (e.g., wireless physical links between the UE 902, the RRH 904, and the virtual RAN 906, as well as the N3 and N6 5G reference points. The NSI may further include MEC reference points such as the Mp1 reference points between the MEC app 914 within the local data network 912 and the MEC platform VNF 918.

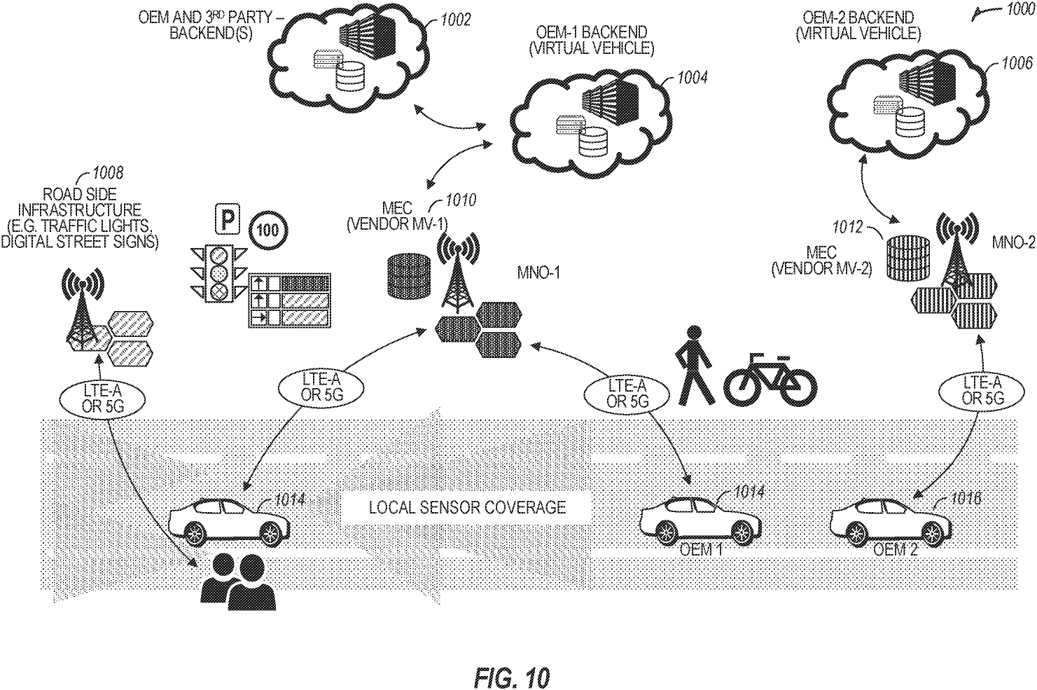

FIG. 10 illustrates a V2X multi-stakeholder communication scenario 1000 which can be used in connection with federated management functions, according to an example embodiment. Referring to FIG. 10, the illustrated MEC federation scenario of V2X services (i.e. multi-MNO, multi-OEM, multi-MEC) includes MEC providers MNO1 1010 and MNO2 1012, a road side infrastructure (e.g., smart traffic lights or digital street signs), a third party backend 1002, OEM backends 1004 and 1006 (associated with MEC providers 1010 and 1012 respectively), and vehicles 1014 and 1016 (associated with MEC providers 1010 and 1012 respectively).

In the V2X multi-stakeholder communication scenario 1000, a V2X application instance may be running on a vehicle 1014 connected to MNO1 1010 which is equipped with a MEC system from vendor 1, and communicating with another V2X application instance, running on a server, or, in general, on a second vehicle 1016 connected to MNO2 1012, which, in its turn, is equipped with a MEC system from vendor 2.

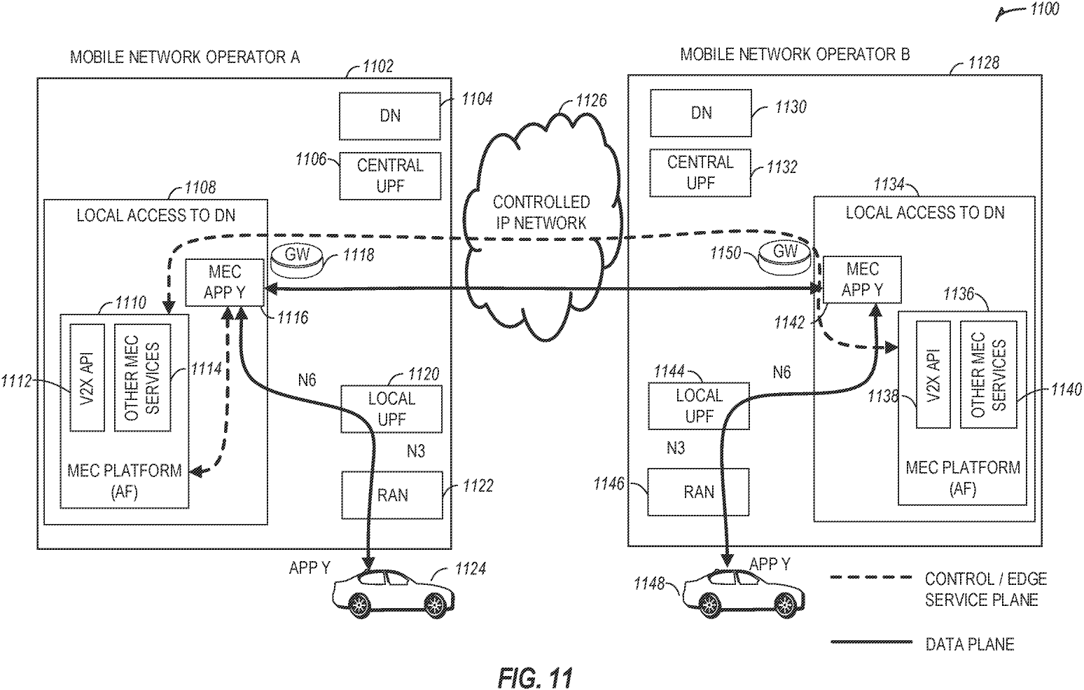

FIG. 11 illustrates a MEC federation reference scenario 1100 for a multi-OEM vehicle use case where both MNOs have MEC platforms with instantiated MEC application Y (“MEC App Y”), according to an example embodiment. Referring to FIG. 11, the federation reference scenario 1100 includes communication between MNO 1102 and MNO 1128 as well as vehicles 1124 and 1148. MNO 1102 includes a MEC host 1108 with a MEC platform 1110 and executing MEC app Y 1116. The MEC platform 1110 includes a V2X application programming interface (API) 1112 as well as other MEC services 1114. The MNO 1102 further includes a gateway 1118, a data network (DN) 1104, a central user plane function (UPF) 1106, a local UPF 1120, and a RAN 1122.

MNO 1128 includes a MEC host 1134 with a MEC platform 1136 and executing MEC app Y 1116 (apps 1116 and 1142 being the same app but executed as separate app instances on different hosts). The MEC platform 1128 includes a V2X API 1138 as well as other MEC services 1140. The MNO 1102 further includes a gateway 1150, a DN 1130, a central UPF 1132, a local UPF 1144, and a RAN 1146. Communication between the MEC hosts 1108 and 1134 takes place via the gateways 1118, 1150, and the IP network 1126. Communication between the vehicle 1124 and the MEC app 1116 takes place via the RAN 1122 and the local UPF 1120. Communication between the vehicle 1148 and the MEC app 1142 takes place via the RAN 1146 and the local UPF 1144.

From a network architecture point of view, the federation reference scenario 1100 is similar to the V2X multi-stakeholder communication scenario 1000 in FIG. 10. More specifically, FIG. 11 illustrates a certain V2X service is implemented with two instances of the MEC App Y, each of which communicates with its corresponding client application (or app), i.e., “App Y”, and is also connected with a MEC platform in each respective MEC system (domain).

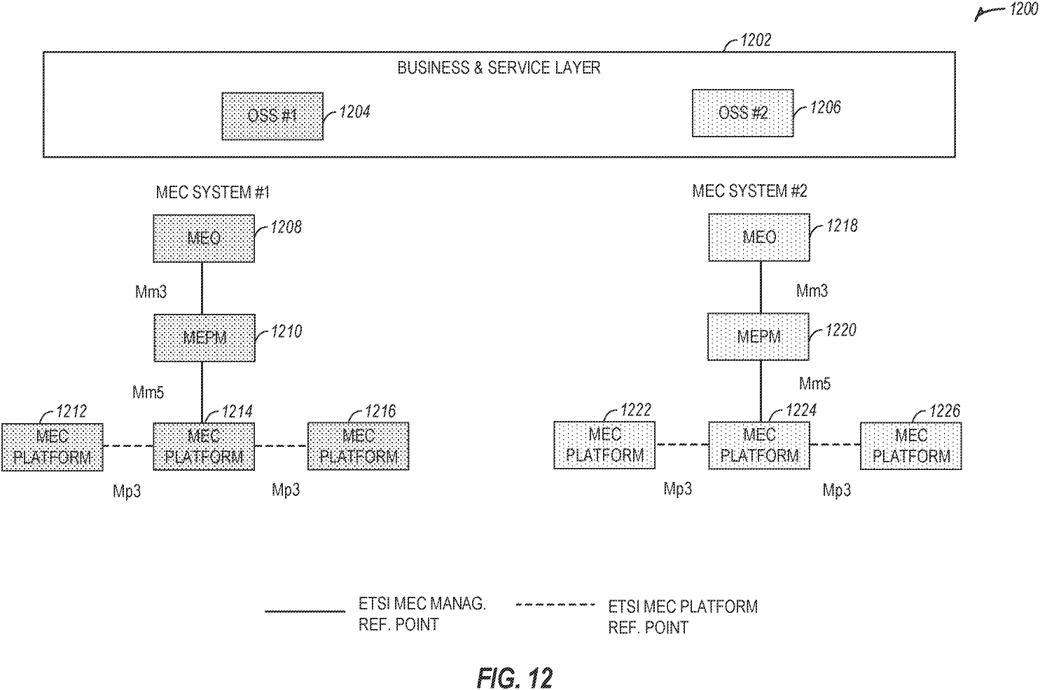

FIG. 12 illustrates an exemplary MEC system deployment scenario 1200 per ETSI MEC reference architecture including a service layer that can be used in connection with federated management functions, according to an example embodiment. Referring to FIG. 12, the exemplary MEC system deployment scenario 1200 is associated with communication between MEC system 1 and MEC system 2. MEC system 1 includes an OSS 1204 as part of service layer 1202, MEO 1208, and MEC platform manager (MECPM) 1210 coupled to MEC platforms 1212, 1214, and 1216. MEC system 2 includes an OSS 1206 as part of service layer 1202, MEO 1218, and MECPM 1220 coupled to MEC platforms 1222, 1224, and 1226. The MEC system deployment scenario 1200 further illustrates MEC management reference points and MEC platform reference points used by the MEC systems 1 and 2.

Inter-MEC system communication is impactful to MNOs. ETSI MEC GS 003 specifies three high-level requirements for inter-MEC system communication, along with a hierarchical framework for inter-MEC system discovery and communication described as follows: (a) A MEC platform should be able to discover other MEC platforms that may belong to different MEC systems; (b) A MEC platform should be able to exchange information securely with other MEC platforms that may belong to different MEC systems; (c) A MEC application should be able to exchange information securely with other MEC applications that may belong to different MEC systems.

To enable the inter-MEC system communication, the following hierarchical inter-MEC system discovery and communication frameworks are assumed: (a) MEC system-level inter-system discovery and communication; and (b) MEC host-level inter-system communication between the MEC platforms.

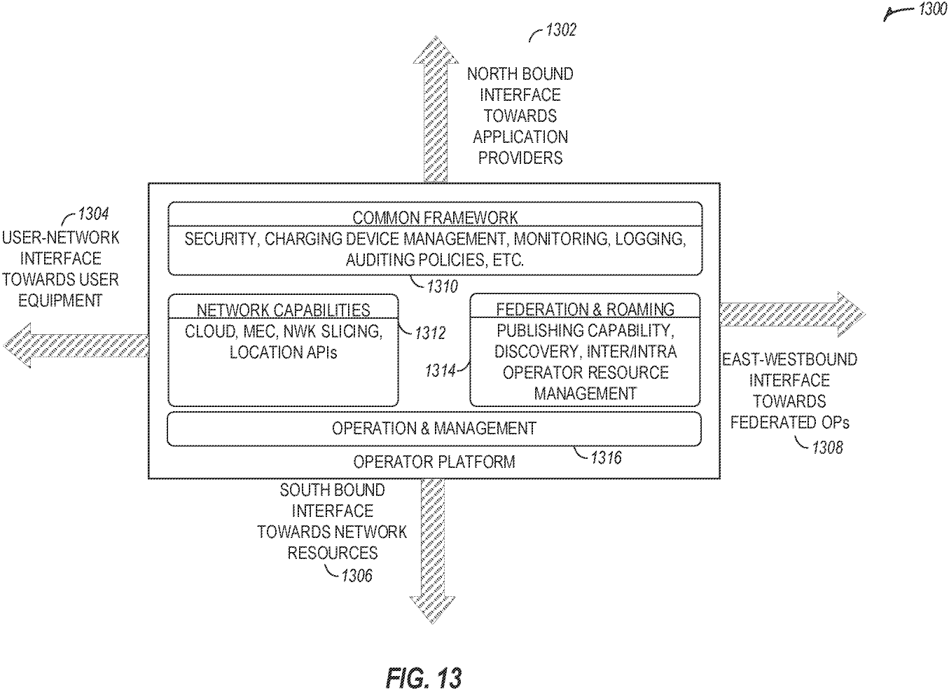

Driven by the MNOs′ interest to form federated MEC environments, Inter-MEC systems, and MEC-Cloud systems coordination can be considered in connection with federated management functions. The “operator platform” concept, illustrated in FIG. 13, may also be considered when configuring federated management functions. For example, the operator platform may be configured to federate multiple operators’ edge computing infrastructure to give application providers access to a global edge cloud to run distributed and low latency services through a set of common APIs

FIG. 13 illustrates a high-level GSMA operator platform 1300, according to an example embodiment. Referring to FIG. 13, the operator platform 1300 includes a common framework 1310 for security, charging device management, monitoring, logging, auditing policies, etc. The operator platform 1300 further includes network capabilities 1312 (e.g., cloud networking capabilities, MEC capabilities, network slicing, location APIs, etc.), federation and roaming functions 1314 (e.g., publishing capabilities, discovery, inter-/intra-operator resource management), and operation and management functions 1316. The operator platform 1300 further includes the following interfaces: a northbound interface 1302 towards application providers, east-westbound interface 1308 towards federated networks, southbound interface 1306 towards network resources, and user network interface 1304 towards user equipment.

In this regard, inter-MEC system communication is essential in today’s, as well as the future’s, edge computing industry, and ecosystem. However, to unlock the full potential of federated MEC environments (as the exemplary one in FIGS. 10-11), a well-defined signaling framework among MEC system entities may be used, both at the system level and host level.

A typical MEC Federation scenario of V2X services (i.e. multi-MNO, multi-OEM, multi-MEC) may be considered. The concept to be resolved is how to structure the needed signaling/messages for secure communication among different MEC systems, possibly owned and operated/managed by different entities (e.g., Mobile Network Operators - MNOs) for the needs of information exchange. Such information exchange refers to either a MEC application in need of consuming a MEC platform service or a MEC application in need of communicating with other (service-producing) MEC applications.

In an example embodiment, a hierarchical signaling framework is used for realizing a MEC federation constituting of MEC systems, possibly owned and operated by different parties (e.g., MNOs). This signaling framework may refer to the following hierarchical inter-MEC system communication levels:

(a) MEC system (i.e., below business level) discovery, including security (authentication/ authorization, system topology hiding/encryption), charging, identity management, and monitoring aspects as an essential prerequisite to forming a MEC federation;

(b) MEC platform discovery, either at high granularity (i.e., MEC platform) or, low granularity (e.g., zone, zone group, NFVI Point-of-Presence, NFVI node if a needed service is deployed as a VNF); and

(c) Information exchange at MEC platform level, for the needs of MEC service consumption, or MEC app-to-app communication.

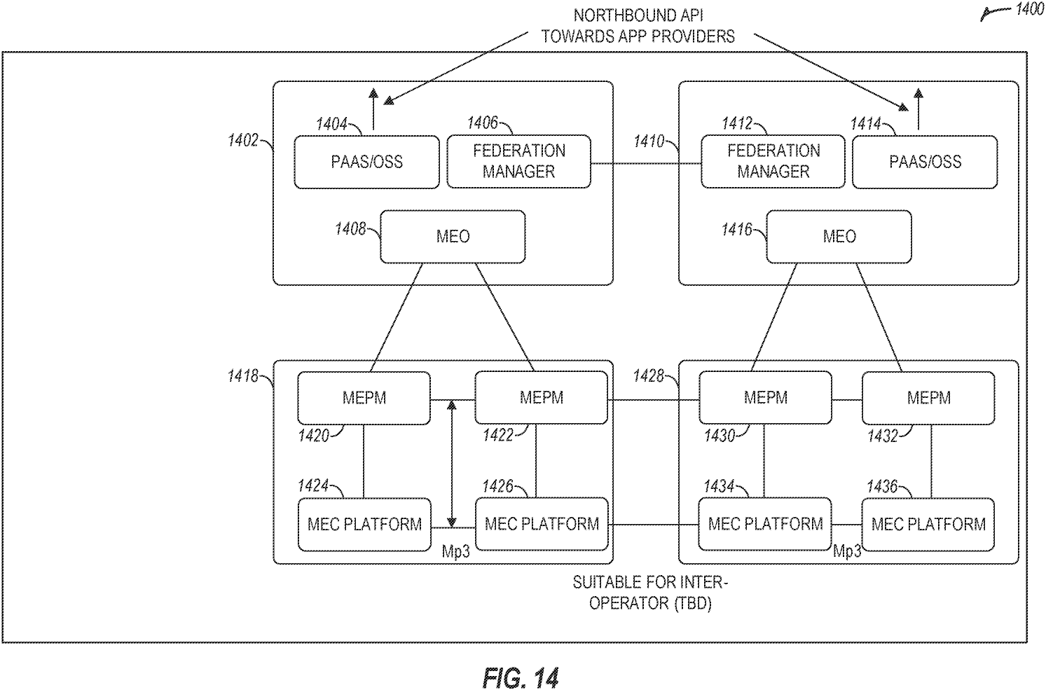

FIG. 14 illustrates hierarchical functional levels based on which a MEC federation can be formed, according to an example embodiment. Referring to FIG. 14, the hierarchical signaling framework 1400 is formed using network management entities 1402 associated with a first MEC system and network management entities 1410 associated with a second MEC system. The network management entities 1402 include an OSS 1404, a federation manager 1406, and MEO 1408. The network management entities 1402 are coupled to additional MEC entities 1418 including MEPM 1420 coupled to a MEC platform 1424 and MEPM 1422 coupled to a MEC platform 1426. The network management entities 1410 include an OSS 1414, a federation manager 1412, and MEO 1416. The network management entities 1410 are coupled to additional MEC entities 1428 including MEPM 1430 coupled to a MEC platform 1434 and MEPM 1432 coupled to a MEC platform 1436. The hierarchical signaling framework 1400 can be configured to perform federation management functions as discussed herein.

Existing techniques associated with inter-MEC system communication do not include the disclosed federation management functions associated with communication in MEC federation scenarios for achieving MEC system discovery, MEC platform discovery, and inter-MEC platform information exposure.

In comparison, disclosed techniques can be used to configure a hierarchical signaling framework implementing a MEC federation of MEC systems (e.g., possibly owned and operated by different parties such as MNOs). This signaling framework refers to the following hierarchical inter-MEC system communication levels: (a) MEC system (i.e., below business level) discovery, including security (authentication/ authorization, system topology hiding/ encryption), charging, identity management, and monitoring aspects as an essential prerequisite to forming a MEC federation; (b) MEC platform discovery, either at high granularity (i.e., MEC platform) or, low granularity (eg., zone, zone group, NFVI Point-of-Presence, NFVI node if a needed service is deployed as a VNF); and (c) Information exchange at MEC platform level, for the needs of MEC service consumption, or MEC app-to-app communication. Additionally, the disclosed techniques can be used to facilitate the establishment of MEC applications and adoption from stakeholders in interoperable scenarios. Such a development will enable and support the MNOs′ needs to form MEC system federations aiming to enhance service performance (e.g., facilitating V2X service continuity in automotive communication scenarios).

In some embodiments, the disclosed techniques associated with federation management functions are used to address the needs of information exchange, for the needs of MEC/edge service consumption, which is related to section (c) in the above list of communication levels. Such information exchange refers to either a MEC application in need of consuming a MEC platform service or a MEC application in need of communicating with others (e.g., service-producing) MEC applications.

### Information Exchange at MEC Platform Level for MEC Service Consumption or MEC App-to-App Communication

The following describes federation management functions (from a MEC application perspective) when an application wants to consume edge services through a MEC system. A description of processing associated with the above sections (a) and (b) follows as well, to clarify how MEC system discovery, including security (authentication/ authorization, system topology hiding/ encryption), charging, identity management and monitoring aspects, and MEC platform discovery are realized. For section (c), edge service consumption in a single MEC system is described, followed by a description of edge service consumption in a federated MEC network.

### Edge Service Consumption in a Single MEC System

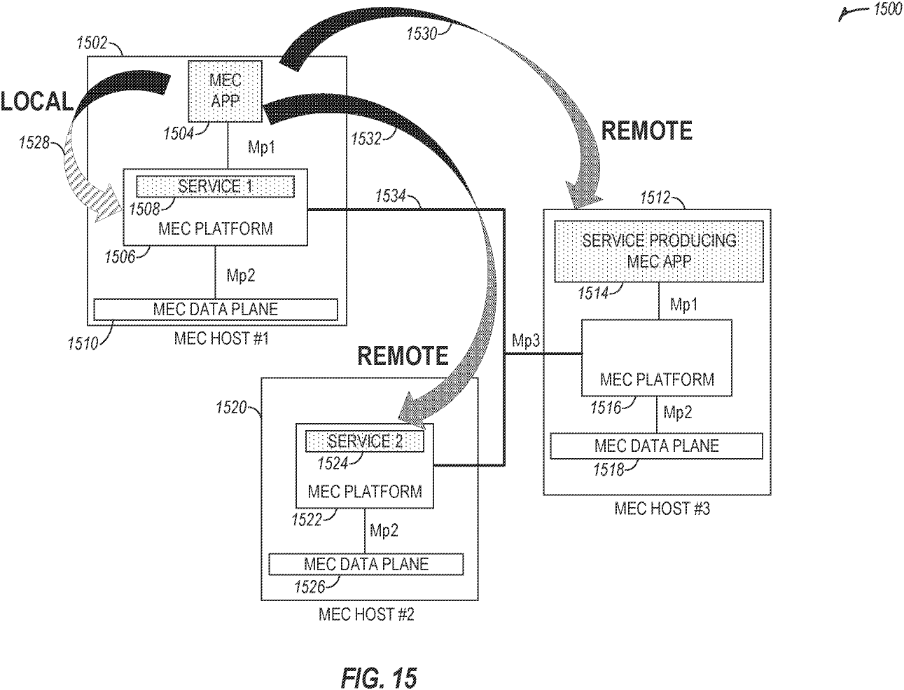

FIG. 15 illustrates service consumption options within a single MEC system 1500, according to an example embodiment. Referring to FIG. 15, the MEC system includes MEC hosts 1502, 1512, and 1520. MEC host 1502 includes a MEC platform 1506 providing service 1508, a MEC app 1504 executing on top of the MEC platform 1506, and MEC data plane 1510. MEC host 1520 includes a MEC platform 1522 providing service 1524 and MEC data plane 1526. MEC host 1512 includes a MEC platform 1516, a service producing MEC app 1514 executing on top of the MEC platform 1516, and MEC data plane 1518.

In a single MEC system 1500, the MEC app 1504 running on MEC host 1502 consumes MEC services instantiated on another MEC host within the MEC system. The queried services are assumed available in the MEC system, however, such services may run at different localities. In FIG. 15, three general cases of edge services consumption are depicted. More specifically, MEC app 1504 can consume service 1508 on the same host 1502 via communication link 1528. MEC app 1504 can also consume service 1524 and service associated with the service-producing MEC app 1514 via corresponding communication links 1532 and 1530. For both remote service consumption cases at MEC hosts 1520 and 1512, the MEC app 1504 can consume the indicated services via the Mp3 reference point 1534 that connects different MEC platforms of the same MEC system.

### Edge Service Consumption in a MEC Federation

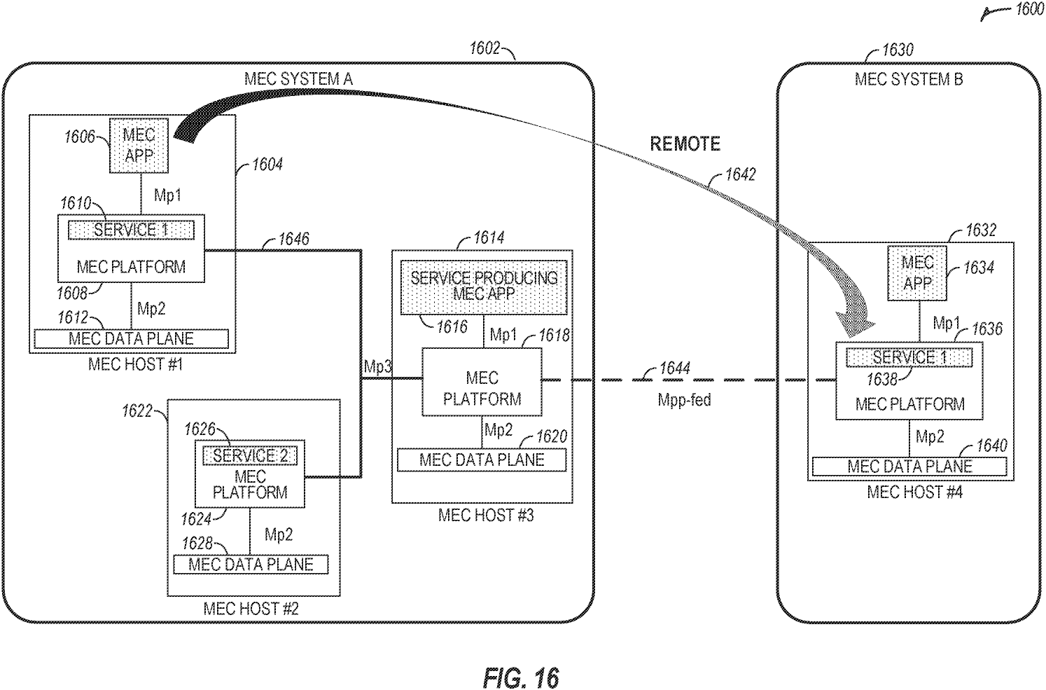

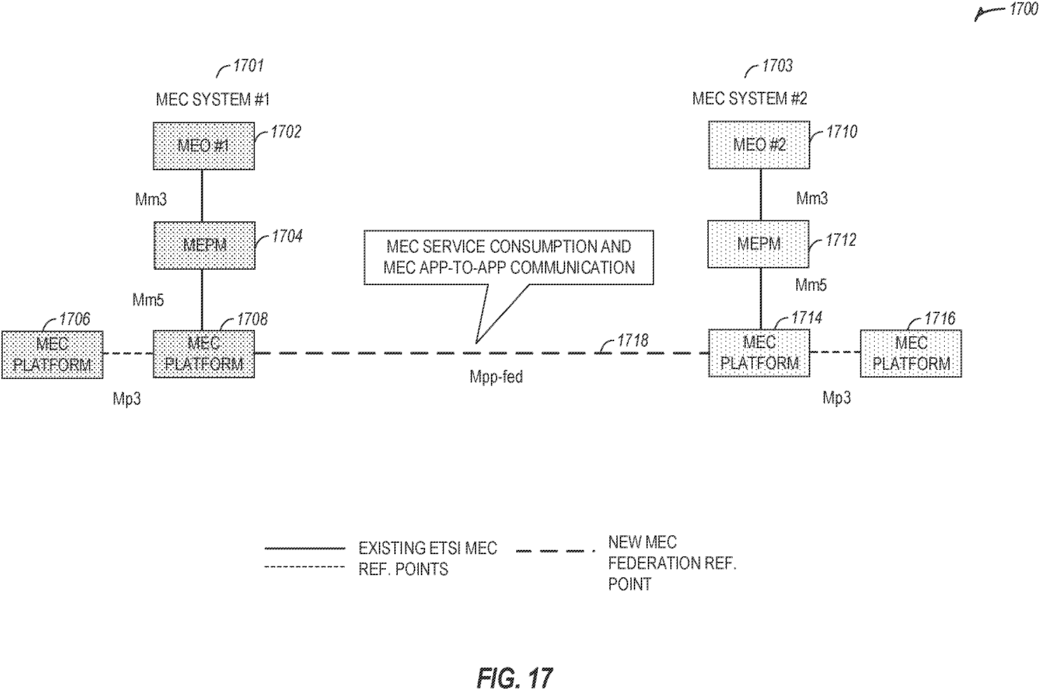

The following description relates to a MEC federation scenario that involves multiple MEC systems belonging to different (technical and/or administrative) domains. In a general case, the MEC hosts belong to different MEC systems (i.e., provided by different MEC vendors), potentially running on different MNOs networks, or in different domains. In this context, a MEC application can consume MEC services available by other MEC hosts, belonging to other MEC systems using a federated MEC Mpp-fed reference point connecting inter-system MEC platforms and, hence, allowing edge service consumption in MEC federation scenarios, as illustrated in FIG. 16 and FIG. 17.

FIG. 16 illustrates a MEC federation scenario enabling edge service consumption across MEC systems, according to an example embodiment. Referring to FIG. 16, the MEC federation 1600 includes the MEC system 1602 and MEC system 1630. MEC system 1602 includes MEC hosts 1604, 1622, and 1614. MEC host 1604 includes a MEC platform 1608 providing service 1610, a MEC app 1606 executing on top of the MEC platform 1608, and a MEC data plane 1612. MEC host 1622 includes a MEC platform 1624 providing service 1626 and MEC data plane 1628. MEC host 1614 includes a MEC platform 1618, a service producing MEC app 1616 executing on top of the MEC platform 1618, and a MEC data plane 1620.

MEC host 1632 in MEC system 1630 includes a MEC platform 1636 providing service 1638, a MEC app 1634 executing on top of the MEC platform 1636, and a MEC data plane 1640.

As illustrated in FIG. 16, MEC app 1606 can consume services within its own MEC system 1602 using the Mp3 reference point 1646 connecting MEC platforms 1608, 1618, and 1624. In an example embodiment, MEC app 1606 can also consume service in a remote MEC system within the MEC federation 1600 via communication link 1642 which can use a federated MEC Mpp-fed reference point 1644 between MEC platforms 1618 and 1636 in different MEC systems (e.g., MEC system 1602 and MEC system 1630).

FIG. 17 illustrates a MEC federation scenario including communication between two MEC platforms belonging to two MEC systems of a MEC federation using an Mpp-fed reference point, according to an example embodiment. Referring to FIG. 17, there is illustrated a communication scenario in a federated MEC network 1700 which is similar to the communication scenario in FIG. 16. More specifically, the federated MEC network 1700 includes a first MEC system 1701 and a second MEC system 1703. The first MEC system 1701 includes MEC management entities such as MEO 1702 and MEPM 1704. The MEPM 1704 is coupled to MEC platforms 1708 and 1706 which can be configured within different MEC hosts. The second MEC system 1703 includes MEC management entities such as MEO 1710 and M EPM 1712. The MEPM 1712 is coupled to MEC platforms 1714 and 1716 which can be configured within different MEC hosts.

In some embodiments, MEC service consumption, MEC app-to-app communication, or another type of information exchange within the MEC federation network 1700 can be performed via the federated MEC Mpp-fed reference point 1718 between MEC platforms 1708 and 1714 in different MEC systems 1701 and 1703.

### MEC System Discovery (e.g., Security. Charging, Identity Management, and Monitoring) for Forming a MEC Federation

The previous description may be considered for defining a reference point that may support information exchange at the MEC platform level, for the needs of MEC service consumption, or MEC app-to-app communication. The communication framework related to MEC system discovery (including security, charging, identity management, and monitoring aspects) and MEC platform discovery may be covered by a hierarchical communication approach as discussed herein.

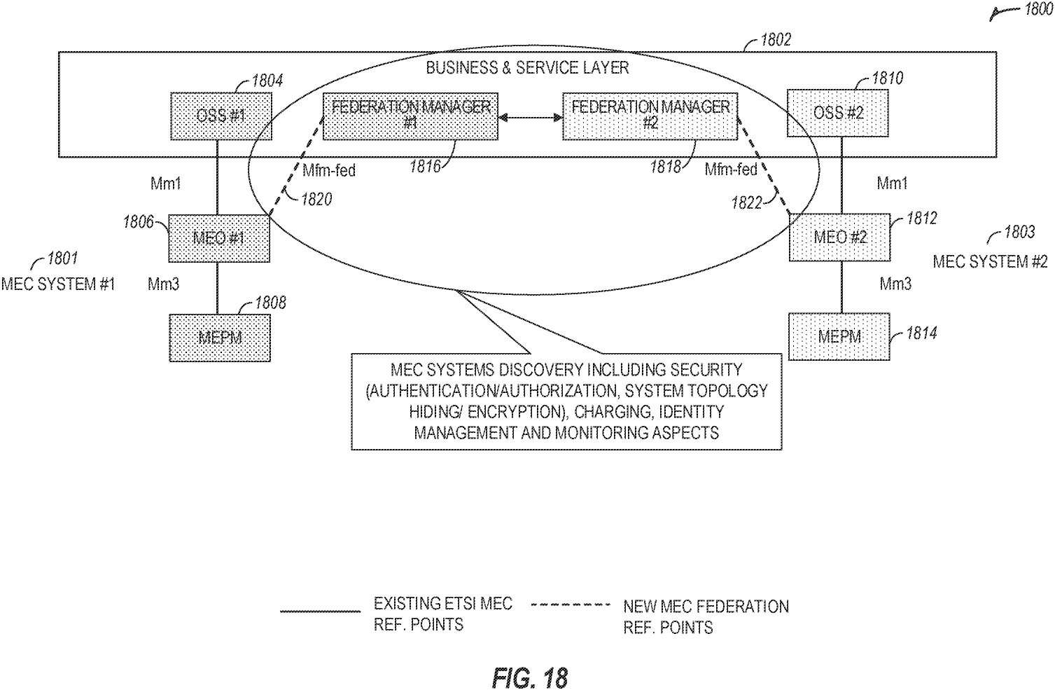

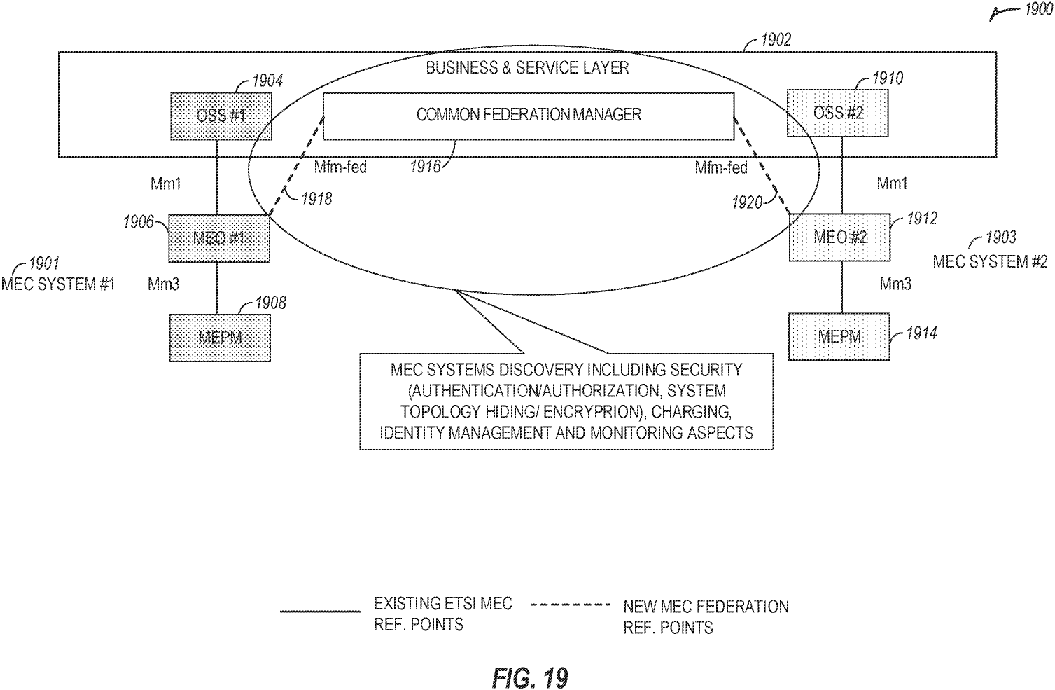

As a prerequisite, before inter-MEC system communication takes place to enable service consumption, the MEC system #1 (and in particular MEO #1) may identify which MEC systems are members of an already established MEC federation or which MEC systems are available to form a new MEC federation. This identification phase of MEC systems can be performed by a federation manager entity (e.g., as discussed in connection with FIG. 18 and FIG. 19), which is configured to manage the catalog of MEC systems involved in the federation. Furthermore, not only the MEC system identification is made possible by a federation manager, but also further information relevant to security (authentication/ authorization, system topology hiding/ encryption), charging, identity management, and monitoring aspects may be managed by the federation manager as well. In other words, the federation manager deals with all the authentication/authorization/charging policies among the various MEC systems (and in particular the respective MEOs), according to which inter-MEC-system communication is allowed and can be realized.

The following use cases may be used to illustrate aspects associated with identifying the MEC systems which are part of a MEC federation before inter-MEC system communication for the needs of edge service consumption.

### Type-1 Use Case

About FIG. 11, the client app at car #1 1124 knows only its App ID (i.e., “App Y”) and eventually the service ID to be consumed (or the MEC API, or again the service produced by another MEC App running in another MEC system). In this case, a certain car, with Car ID#1 is unaware of (and potentially even uninterested in) the other cars’ IDs, but simply wants to be admitted to a pool/cluster of cars using a specific App ID (or consuming a certain service with a given ID).

A first example is the one of an Intersection Movement Assistant (IMA), provided by a Smart City (or a software company realizing the use case for the urban administration), where different cars have the App Y installed, and the corresponding MEC Apps are instantiated at different MEC systems It should be noted that this is the most general case. Another example is In-Vehicle Entertainment (IVE), which can consist of a generic video streaming service, that car #1 wants to consume, without knowing actually which other cars are consuming it. Another example is one of software/ firmware over-the-air (SOTA/ FOTA) updates. In the above type-1 use cases, the MEC systems hosting the MEC App corresponding to other cars in the pool are not necessarily known.

### Type-2 Use Cases

About FIG. 11, the client app at car #1 (with its MEC App instantiated in MEC system #1) knows also the ID of car #2 (with its MEC App instantiated in MEC system #2) target peer for communication. As a first example, car #1 wants to communicate expressly with car #2, as they belong to drivers who are friends traveling together (e.g., in a platooning scenario), or belonging to a “social network” of cars consuming a certain V2X service, and thus knowing by definition their respective IDs. The only information known at car #1 is car ID#2 (i.e., UE#2). As a result, the MEC system hosting the MEC App corresponding to car #2 is not necessarily known.

Another example is see-through among cars belonging to different MEC systems. After an initial phase of neighbor discovery (e.g., via PC5), car #1 can get a list of other cars (and their IDs) that could provide the see-through service (i.e., offering their front cameras as a view for car# 1). An on-demand communication between two cars belonging to different MEC systems may be established. In this case, we suppose that after a preliminary phase (due to functions performed by a federation manager), MEO #1 correctly identifies the MEC system #2, concerning car #2 application activity.

Thus, in type-2 use cases, MEO #1 may discover the target MEO which is hosting the MEC App corresponding to car #2 (based on the ID of car #2). In a preliminary MEC system discovery phase, made possible by the federation manager (with the catalog of MEC systems involved in the federation), MEO #1 correctly identifies the MEC system #2, concerning car #2 application activity. Consequently, after this phase, MEO #1 and MEO #2 can directly communicate.

### Type-3 Use Case

About FIG. 11, the client app at car #1 (concerning MEC system #1) knows the ID of Car #2 (target peer for communication), together with the target MEC system #2, in advance. An example can be any of the previous use cases, where the information about some of the other MEC systems is known in advance, e.g., because of the presence of an “aggregator” between few operators (not necessarily all operators in the federation). In this case, the target MEO #2 can be known, but for sake of generality, the other MEOs in the federation are not known. Thus, still, the role of the federation manager is needed to ensure interoperability and generality (i.e., guarantee a standard approach to MEC federation independent from the particular deployment/agreement among some operators)

In some embodiments, after a service communication query is issued by a MEC App instantiated at MEC system #1, the MEO #1 is contacting its corresponding federation manager, as a very first step, before starting the communication with other MEOs (known or not). Consequently, in the context of the present disclosure, the first phase of the communication between MEC systems is made possible with the addition of a federation management reference point Mfm-fed (between the MEO and its corresponding federation manager), as illustrated in FIG. 18 and FIG. 19.

FIG. 18 illustrates a MEC federation scenario including communication using an Mfm-fed federation management reference point connecting a MEC system MEO with a federation manager present in each MEC system, according to an example embodiment. Referring to FIG. 18, there is illustrated a communication scenario in a federated MEC network 1800 The federated MEC network 1800 includes a first MEC system 1801 and a second MEC system 1803. Each of the MEC systems is associated with its federation manager within the service layer 1802. For example, MEC system 1801 is associated with federation manager 1816, and MEC system 1803 is associated with federation manager 1818.

The first MEC system 1801 includes MEC management entities such as OSS 1804 (within the service layer 1802), MEO 1806, and MEPM 1808. The MEPM 1808 may be coupled to MEC platforms which can be configured within different MEC hosts. The second MEC system 1803 includes MEC management entities such as OSS 1810 (within the service layer 1802), MEO 1812, and MEPM 1814. The MEPM 1814 may be coupled to MEC platforms which can be configured within different MEC hosts.

In some embodiments, MEC systems discovery including security (authentication/authorization, system topology hiding/encryption), charging, identity management, and monitoring aspects (as well as other federation management functions) are performed by the federation managers 1816 and 1818 using the federated MEC Mfm-fed reference points 1820 (between the MEO 1806 and the federation manager 1816) and 1822 (between MEO 1812 and federation manager 1818) within the MEC federation network 1800

In some embodiments, a federation management entity (eg., a federation manager) is used for each MEC system (e.g., as illustrated in FIG. 18). Optionally, a federation broker may be used, where the federation broker may manage multiple federation managers and configure communications between such managers or perform other federation management functions associated with the corresponding MEC systems associated with the federation managers. In other embodiments, a common federation management entity (e.g., a common federation manager) may be used for the entire federated MEC network (e.g., as illustrated in FIG. 19).

FIG. 19 illustrates a MEC federation scenario including communication using an Mfm-fed federation management reference point connecting a MEC system MEO with a common federation manager associated with multiple MEC systems, according to an example embodiment. Referring to FIG. 19, there is illustrated a communication scenario in a federated MEC network 1900 (which can also be referred to as a MEC federation or MEC federation network). The federated MEC network 1900 includes a first MEC system 1901 and a second MEC system 1903. Both MEC systems 1901 and 1903 use a common federation manager 1916 within the service layer 1902.

The first MEC system 1901 includes MEC management entities such as OSS 1904 (within the service layer 1902), MEO 1906, and MEPM 1908. The MEPM 1908 may be coupled to MEC platforms which can be configured within different MEC hosts. The second MEC system 1903 includes MEC management entities such as OSS 1910 (within the service layer 1902), MEO 1912, and MEPM 1914. The MEPM 1914 may be coupled to MEC platforms which can be configured within different MEC hosts.

In some embodiments, MEC systems discovery including security (authentication/authorization, system topology hiding/encryption), charging, identity management, and monitoring aspects (as well as other federation management functions) are performed by the common federation manager 1916 using the federated MEC Mfm-fed reference points 1918 (between the MEO 1906 and the common federation manager 1916) and 1920 (between MEO 1912 and the common federation manager 1916) within the MEC federation network 1900.

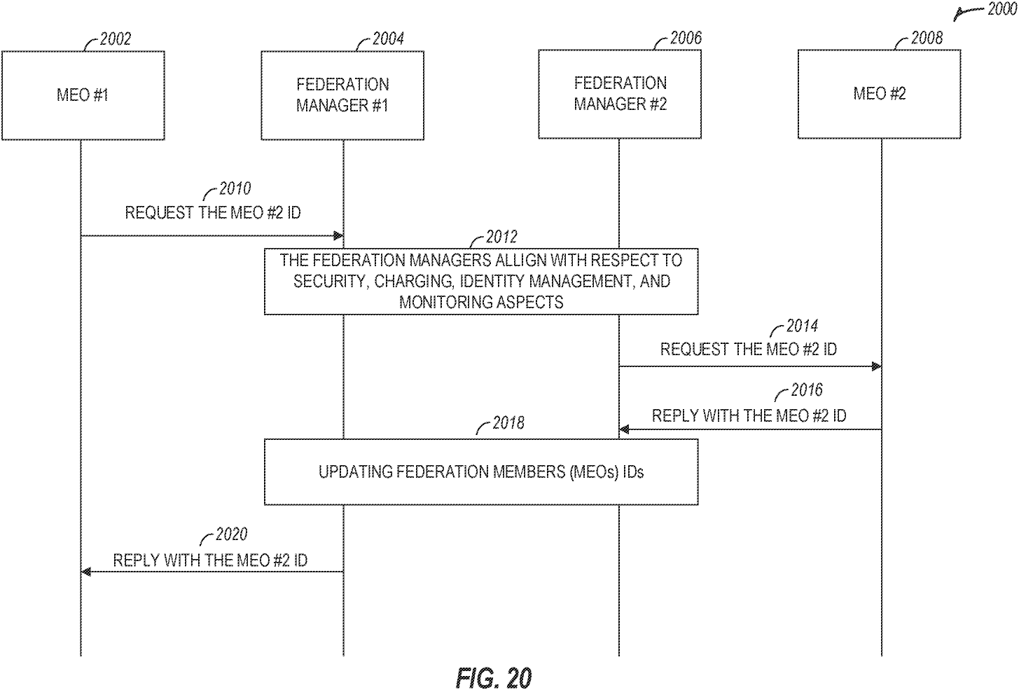

Independently of the above embodiments associated with FIG. 18 and FIG. 19, in both cases, after addressing security (authentication/authorization, system topology hiding/ encryption), charging, identity management, and monitoring aspects, the MEO receives from the federation manager the IDs of other MEOs that it can communicate with. An example communication sequence is illustrated in FIG. 20.

FIG. 20 is a message sequence chart between multiple federation managers and MEOs in a federated MEC network, according to an example embodiment. Referring to FIG. 20, the communication sequence 2000 takes place between a first MEO 2002 (in a first MEC system), a first federation manager 2004 (of the first MEC system), a second MEO 2008 (of a second MEC system), and a second federation manager 2006 (of the second MEC system) The entities associated with the communication sequence 2000 can be the same as illustrated in FIG. 18 or FIG. 19.

At operation 2010, MEO 2002 requests the MEO ID of the second MEO 2008. At operation 2012, federation managers 2004 and 2006 align with respect to security, charging, identity management, and monitoring aspects. At operation 2014, federation manager 2006 requests the MEO ID from MEO 2008 At operation 2016, MEO 2008 responds with its MEO ID. At operation 2018, both federation managers update corresponding lists of MEC federation members, which may include lists of MEO IDs of MEOs in participating MEC systems. At operation 2020, federation manager 2004 provides the MEO ID of MEO 2008 to MEO 2002. In the above communication sequence 2000, communications between the MEC MEOs and the corresponding federation managers takes place using corresponding federated MEC Mfm-fed reference points.

### MEC Platform Discovery (at High or Low Granularity)

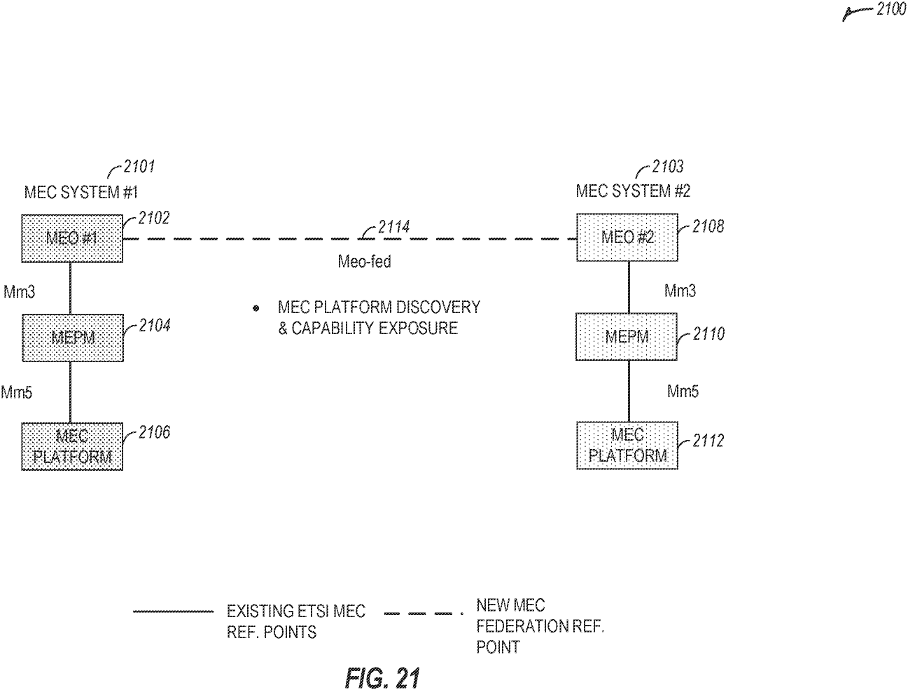

In some embodiments, MEC platform discovery can be used as another component of the disclosed federated management functions. More specifically, disclosed techniques may be used by a MEC platform to discover other MEC platforms that may belong to different MEC systems. In some aspects, the MEC platform discovery can be made possible by communication between MEOs, which are aware of their MEC system topologies and all information about the MEC platforms in their respective systems. In an example embodiment, the MEC platform discovery may use a federated MEC Meo-fed reference point among MEOs of a MEC federation, as illustrated in introduced in FIG. 21.

FIG. 21 illustrates a MEC federation scenario including communication using a Meo-fed federation management reference point connecting MEOs in a federated MEC network, according to an example embodiment Referring to FIG. 21, there is illustrated a communication scenario in a federated MEC network 2100 which includes a first MEC system 2101 and a second MEC system 2103. The first MEC system 2101 includes MEC management entities such as MEO 2102 and MEPM 2104. The MEPM 2104 is coupled to a MEC platform 2106 which can be configured within a MEC host. The second MEC system 2103 includes MEC management entities such as MEO 2108 and MEPM 2110. The MEPM 2110 is coupled to MEC platform 2112 which can be configured within a MEC host.

In some embodiments, MEC platform discovery and capabilities exposure within the MEC federation network 2100 can be performed via the federated MEC Meo-fed reference point 2114 between the MEO 2102 and the MEO 2108. For example, MEO 2102 and MEO 2108 use the federated MEC Meo-fed reference point 2114 to exchange information about their MEC platforms, list of shared services, authorization, and access policies, etc.

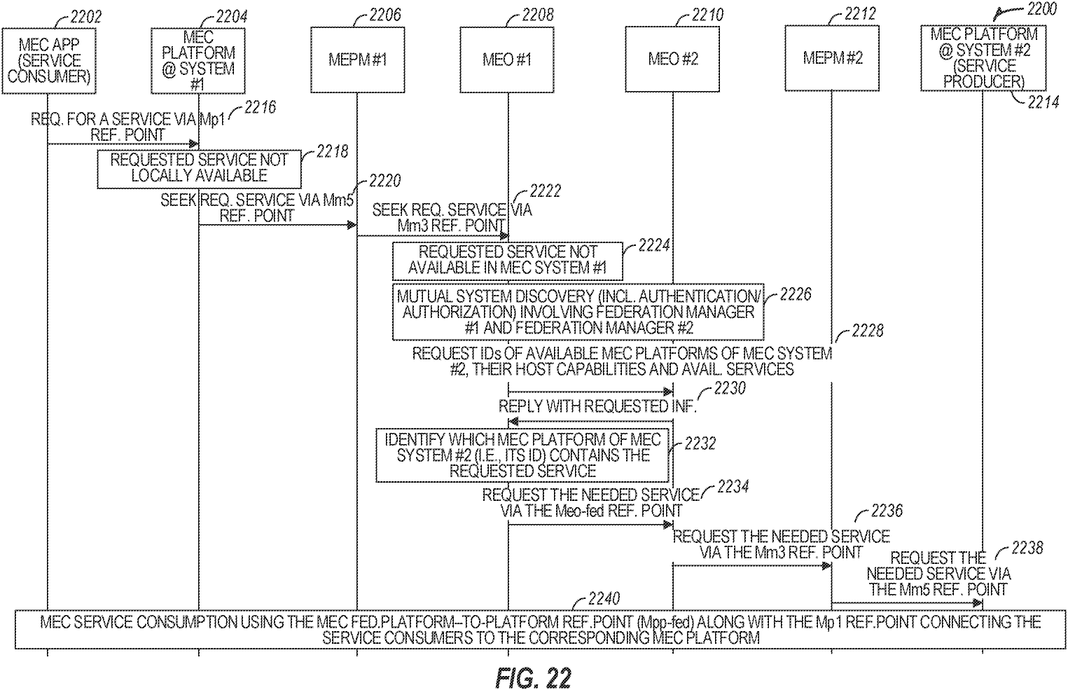

FIG. 22 illustrates a sequence diagram 2200 of signaling for establishing hierarchical inter-MEC system communication for service consumption in a federated MEC network, according to an example embodiment. In the sequence diagram 2200, the disclosed signaling framework may be used, focusing as an example of type-1 use cases (i.e., car #1 only knows the service and application IDs). The illustrated communication sequence can take place between the following entities: MEC app (or service consumer) 2202, MEC platform (at a first MEC system) 2204, a first MEPM 2206, a first MEO 2208, a MEC platform 2214 (at a second MEC system), a second MEO 2210, and a second MEPM 2212.

At operation 2216, the service consumer 2202 (i.e., a MEC application instantiated in MEC system #1) requests a needed service via the Mpl reference point using its ID. At operation 2218, the respective MEC platform 2204 in MEC system #1 finds that the requested service is not locally available and forwards the service request (at operation 2220) to the MEPM 2206 of the MEC system #1. At operation 2222, MEPM 2206, in its turn, forwards the service request to MEO 2208.

MEO 2208, which has an overview of the topology and available services of MEC system #1 determines (at operation 2224) that the requested service is not available across MEC system #1. This triggers the need for out-of-system service consumption. To accomplish that, at operation 2226, MEC system discovery is performed as a first step of forming a new (or, joining an already established) MEC federation (i.e., the federation manager, following a request by MEO 2208 via the Mfm-fed reference point informs MEO #1 of the MEO #2 ID, as illustrated in FIG. 20). Mutual discovery of MEC systems #1 and #2, including security (authentication/authorization, system topology hiding/ encryption), charging, identity management, and monitoring aspects are performed by the two corresponding federation managers (or a common federation manager).

After MEC system discovery, MEO 2208 knows the ID of MEO 2210 and communicates (at operation 2228) with MEO 2210 via the Meo-fed reference point, requesting the IDs of the available MEC platforms of MEC system #2, their host capabilities, and available services. At operation 2230, MEO 2210 replies with the requested information. At operation 2232, MEO 2208 identifies which MEC platform of MEC system #2 (i.e., its ID) contains the service requested by the service consumer, i.e., the MEC App instantiated at MEC system #1 and shares the request with MEO #2 (at operation 2234). At operation 2236, MEO 2210 requests the needed service from MEPM 2212 via the Mm3 reference point. At operation 2238, MEPM 2212 requests the needed service from the destined MEC platform 2214 of MEC system #2 via the Mm5 reference point. At operation 2240, MEC service consumption is carried out using the inter-MEC system platform-to-platform reference point (Mpp-fed), along with the Mp 1 reference point connecting the service consumer with its corresponding MEC platform of MEC system #1.

The procedure depicted in FIG. 22 concerns the case where MEC system #1 and MEC system #2 are, after the needed signaling, part of the same MEC federation (i.e., business agreement), but the UE Apps installed in the cars (belonging to different MEC systems) are not necessarily aware of this MEC federation. Thus, in some embodiments, any upcoming service requests that cannot be satisfied within MEC system #1 will be forwarded to the corresponding MEO which will identify whether the sought service is available anywhere in the MEC federation (e.g. other MEC system #2).

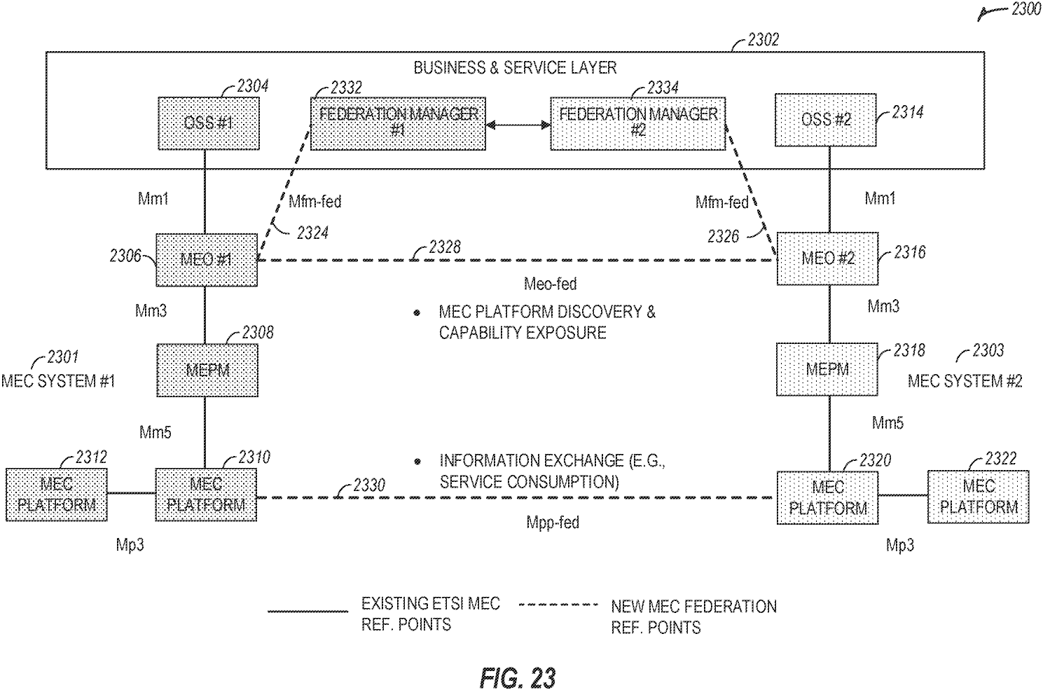

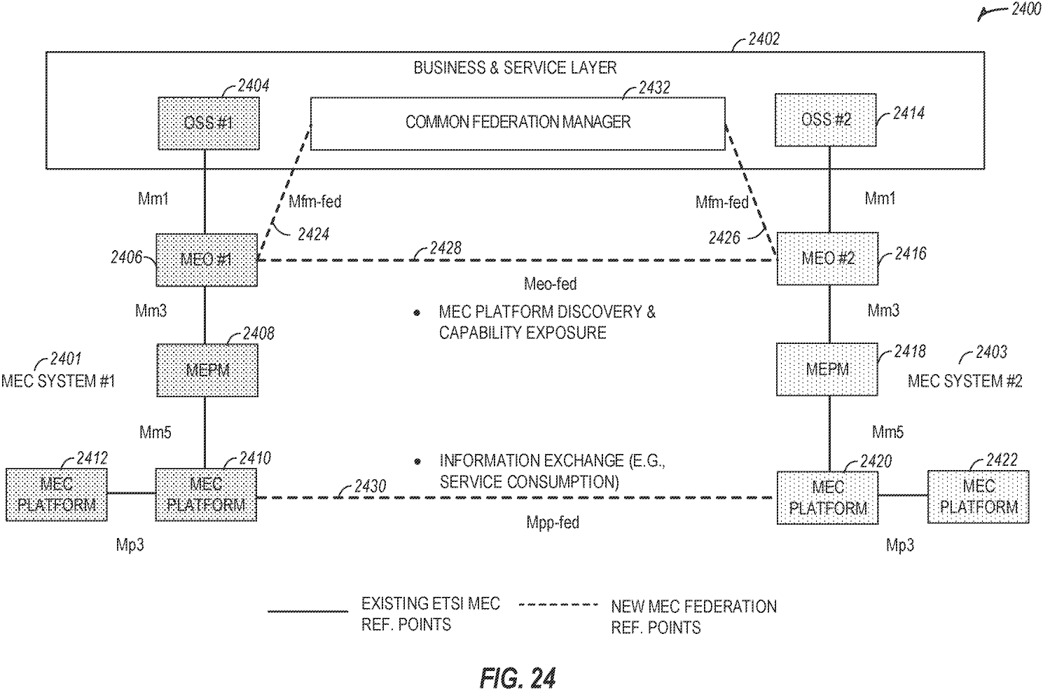

The overall set of disclosed MEC federation reference points (Mfm-fed, Meo-fed, and Mpp-fed) introduced by the present disclosure are depicted in FIG. 23 and FIG. 24 for both variants/embodiments of having multiple federation managers or a single, overall/common federation manager, respectively.

FIG. 23 illustrates MEC federation reference points in a federated MEC network using a separate federation manager per MEC system, according to an example embodiment. Referring to FIG. 23, there is illustrated a communication scenario in a federated MEC network 2300. The federated MEC network 2300 includes a first MEC system 2301 and a second MEC system 2303. Each of the MEC systems is associated with its federation manager within the service layer 2302. For example, MEC system 2301 is associated with federation manager 2332, and MEC system 2303 is associated with federation manager 2334.

The first MEC system 2301 includes MEC management entities such as OSS 2304 (within the service layer 2302), MEO 2306, and MEPM 2308. The MEPM 2308 may be coupled to MEC platforms 2310 and 2312 which can be configured within different MEC hosts. The second MEC system 2303 includes MEC management entities such as OSS 2314 (within the service layer 2302), MEO 2316, and MEPM 2318. The MEPM 2318 may be coupled to MEC platforms 2320 and 2322 which can be configured within different MEC hosts.

In some embodiments, MEC federation management functions may be performed (as discussed herein) using MEC federation reference points Mfm-fed 2324 and 2326, Meo-fed 2328 (e.g., for MEC platform discovery and capability exchange), and Mpp-fed 2330 (e.g., for information exchange including service consumption).

FIG. 24 illustrates MEC federation reference points in a federated MEC network using a single federation manager, according to an example embodiment. Referring to FIG. 24, there is illustrated a communication scenario in a federated MEC network 2400 (which can also be referred to as a MEC federation or MEC federation network). The federated MEC network 2400 includes a first MEC system 2401 and a second MEC system 2403 Both MEC systems 2401 and 2403 use a common federation manager 2432 within the service layer 2402.

The first MEC system 2401 includes MEC management entities such as OSS 2404 (within the service layer 2402), MEO 2406, and MEPM 2408. The MEPM 2408 may be coupled to MEC platforms 2410 and 2412 which can be configured within different MEC hosts. The second MEC system 2403 includes MEC management entities such as OSS 2414 (within the service layer 2402), MEO 2416, and MEPM 2418. The MEPM 2418 may be coupled to MEC platforms 2420 and 2422 which can be configured within different MEC hosts.

In some embodiments, MEC federation management functions may be performed (as discussed herein) using MEC federation reference points Mfm-fed 2424 and 2426, Meo-fed 2428 (e.g., for MEC platform discovery and capability exchange), and Mpp-fed 2430 (e.g., for information exchange including service consumption).

FIG. 25 illustrates a flowchart of method 2500 for implementing a federation management entity in a federated MEC network, according to an example embodiment. Referring to FIG. 22 and FIG. 25, at operation 2502, a request for a MEC service is detected (e.g., operation 2216 in FIG. 22). The request may originate from a MEC application (e.g., MEC app 2202) instantiated on a first MEC host within a first MEC system of the federated MEC network. At operation 2504, a second MEC system of the federated MEC network is selected, the second MEC system including a second MEC host providing the MEC service. For example, communication exchange (or negotiation) may take place between the federation managers of the two MEC systems and MEO IDs can be exchanged between the two federation managers to indicate MEC systems and hosts that offer the requested service. At operation 2506, a set of common credentials is determined for secure communication between the first MEC system and the second MEC system. For example, such determination can take place at operation 2216 and can include communication exchanges with the corresponding federation managers via the MEC federation reference points Mfm-fed and Meo-fed. At operation 2508, a response to the request is generated for communication to the first MEC system via a NIC, the response including the set of common credentials and identification information of a MEC management entity in the second MEC system, the MEC management entity in the second MEC system providing access to the MEC service. For example, communication exchange associated with operations 2224 - 2238 leads to MEC service consumption by the MEC app 2202.

It should be understood that the functional units or capabilities described in this specification may have been referred to or labeled as components, circuits, or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

### Additional Examples and Aspects

Example 1 is a computing node to implement a federation management entity associated with a federated Multi-Access Edge Computing (MEC) network, the node comprising: a network interface card (NIC); and processing circuitry coupled to the NIC, the processing circuitry configured to: detect a request for a MEC service, the request originating from a MEC application instantiated on a first MEC host within a first MEC system of the federated MEC network; select a second MEC system of the federated MEC network, the second MEC system including a second MEC host providing the MEC service; determine a set of common credentials for secure communication between the first MEC system and the second MEC system; and generate a response to the request for communication to the first MEC system via the NIC, the response including the set of common credentials and identification information of a MEC management entity in the second MEC system, the MEC management entity in the second MEC system providing access to the MEC service.

In Example 2, the subject matter of Example 1 includes subject matter where the federation management entity is a federation manager of the first MEC system.

In Example 3, the subject matter of Example 2 includes subject matter where the processing circuitry is configured to receive the request for the MEC service from a Mobile Edge Orchestrator (MEO) entity of the first MEC system via a first Mfm-fed MEC federation reference point.

In Example 4, the subject matter of Example 3 includes subject matter where the federation management entity is a common federation manager of the first MEC system and the second MEC system.

In Example 5, the subject matter of Example 4 includes subject matter where the MEC management entity in the second MEC system is an MEO entity of the second MEC system.

In Example 6, the subject matter of Example 5 includes subject matter where the processing circuitry is configured to: receive availability information for the MEC service from the MEO entity of the second MEC system via a second Mfm-fed MEC federation reference point.

In Example 7, the subject matter of any of Examples 3-6 includes subject matter where the request for the MEC service originates from the MEC application instantiated on the first MEC host and is received by the MEO entity from a MEC platform manager of the first MEC system via an Mm3 MEC reference point.

In Example 8, the subject matter of any of Examples 2-7 includes subject matter where the processing circuitry is configured to: encode the request for the MEC service for transmission to a second federation management entity in the federated MEC network.

In Example 9, the subject matter of Example 8 includes subject matter where the second federation management entity is a federation manager of the second MEC system.

In Example 10, the subject matter of any of Examples 8-9 includes subject matter where the processing circuitry is configured to receive a notification from the second federation management entity, the notification including identification information of one or more other MEC systems within the federated MEC network that offer the MEC service, and select the second MEC system from the one or more other MEC systems for providing the MEC service based on the notification.

In Example 11, the subject matter of Example 10 includes subject matter where the notification further includes identification information of Mobile Edge Orchestrator (MEO) entities associated with the one or more other MEC systems that provide the MEC service.

In Example 12, the subject matter of Example 11 includes subject matter where the MEC management entity in the second MEC system is one of the MEO entities identified in the notification, and wherein the identification information comprises an MEO identification (ID) of the MEO entity in the second MEC system.

In Example 13, the subject matter of any of Examples 8-12 includes subject matter where the processing circuitry is configured to determine the set of common credentials via a communication exchange with the second federation management entity.

In Example 14, the subject matter of Example 13 includes subject matter where the set of common credentials further includes service charging credentials and service monitoring credentials associated with accessing the MEC service in the second MEC system.

In Example 15, the subject matter of any of Examples 1-14 includes subject matter where the MEC service is a service-producing MEC application instantiated on the second MEC host.

In Example 16, the subject matter of any of Examples 1-15 includes subject matter where the MEC service is a service of a MEC platform of the second MEC host.

In Example 17, the subject matter of any of Examples 1-16 includes subject matter where the federation management entity is a federation broker entity configured to manage communications between a federation management entity of the first MEC system and a federation management entity of the second MEC system.

Example 18 is at least one machine-readable storage medium comprising instructions stored thereupon, which when executed by processing circuitry of a computing node operable to implement a federation management entity in a federated Multi-Access Edge Computing (MEC) network, cause the processing circuitry to perform operations comprising: detecting a request for a MEC service, the request originating from a MEC application instantiated on a first MEC host within a first MEC system of the federated MEC network, selecting a second MEC system of the federated MEC network, the second MEC system including a second MEC host providing the MEC service; determining a set of common credentials for secure communication between the first MEC system and the second MEC system; and generating a response to the request for communication to the first MEC system, the response including the set of common credentials and identification information of a MEC management entity in the second MEC system, the MEC management entity in the second MEC system providing access to the MEC service.

In Example 19, the subject matter of Example 18 includes subject matter where the federation management entity is a federation manager of the first MEC system.

In Example 20, the subject matter of Example 19 includes subject matter where executing the instructions further cause the processing circuitry to perform operations comprising: receiving the request for the MEC service from a Mobile Edge Orchestrator (MEO) entity of the first MEC system via a first Mfm-fed MEC federation reference point.

In Example 21, the subject matter of Example 20 includes subject matter where the federation management entity is a common federation manager of the first MEC system and the second MEC system.

In Example 22, the subject matter of Example 21 includes subject matter where the MEC management entity in the second MEC system is an MEO entity of the second MEC system.

In Example 23, the subject matter of Example 22 includes subject matter where executing the instructions further cause the processing circuitry to perform operations comprising: receiving availability information for the MEC service from the MEO entity of the second MEC system via a second Mfm-fed MEC federation reference point.

In Example 24, the subject matter of any of Examples 20-23 includes subject matter where the request for the MEC service originates from the MEC application instantiated on the first MEC host and is received by the MEO entity from a MEC platform manager of the first MEC system via an Mm3 MEC reference point.

In Example 25, the subject matter of any of Examples 19-24 includes subject matter where executing the instructions further cause the processing circuitry to perform operations comprising: encoding the request for the MEC service for transmission to a second federation management entity in the federated MEC network.

In Example 26, the subject matter of Example 25 includes subject matter where the second federation management entity is a federation manager of the second MEC system.

In Example 27, the subject matter of any of Examples 25-26 includes subject matter where executing the instructions further cause the processing circuitry to perform operations comprising: receiving a notification from the second federation management entity, the notification including identification information of one or more other MEC systems within the federated MEC network that offer the MEC service, and selecting the second MEC system from the one or more other MEC systems for providing the MEC service based on the notification.

In Example 28, the subject matter of Example 27 includes subject matter where the notification further includes identification information of Mobile Edge Orchestrator (MEO) entities associated with the one or more other MEC systems that provide the MEC service.

In Example 29, the subject matter of Example 28 includes subject matter where the MEC management entity in the second MEC system is one of the MEO entities identified in the notification, and wherein the identification information comprises an MEO identification (ID) of the MEO entity in the second MEC system.

In Example 30, the subject matter of any of Examples 25-29 includes subject matter where executing the instructions further cause the processing circuitry to perform operations comprising: determining the set of common credentials via a communication exchange with the second federation management entity.

In Example 31, the subject matter of Example 30 includes subject matter where the set of common credentials further includes service charging credentials and service monitoring credentials associated with accessing the MEC service in the second MEC system.

In Example 32, the subject matter of any of Examples 18-31 includes subject matter where the MEC service is a service-producing MEC application instantiated on the second MEC host.

In Example 33, the subject matter of any of Examples 18-32 includes subject matter where the MEC service is a service of a MEC platform of the second MEC host.

In Example 34, the subject matter of any of Examples 18-33 includes subject matter where the federation management entity is a federation broker entity configured to manage communications between a federation management entity of the first MEC system and a federation management entity of the second MEC system.

Example 35 is a federation management system comprising: a plurality of hardware components, including a processing circuitry and network communications circuitry, and at least one memory device including instructions embodied thereon, wherein the instructions, which when executed by the processing circuitry, configure the hardware components to perform operations to: detect a request for a Multi-Access Edge Computing (MEC) service, the request originating from a MEC application instantiated on a first MEC host within a first MEC system of a federated MEC network; select a second MEC system of the federated MEC network, the second MEC system including a second MEC host providing the MEC service; determine a set of common credentials for secure communication between the first MEC system and the second MEC system; and generate a response to the request for communication to the first MEC system via the network communications circuitry, the response including the set of common credentials and identification information of a MEC management entity in the second MEC system, the MEC management entity in the second MEC system providing access to the MEC service.

In Example 36, the subject matter of Example 35 includes subject matter where the federation management system is a federation manager of the first MEC system.

In Example 37, the subject matter of Example 36 includes subject matter where the instructions configure the hardware components to receive the request for the MEC service from a Mobile Edge Orchestrator (MEO) entity of the first MEC system via a first Mfm-fed MEC federation reference point.

In Example 38, the subject matter of Example 37 includes subject matter where the federation management system is a common federation manager of the first MEC system and the second MEC system.

In Example 39, the subject matter of Example 38 includes subject matter where the MEC management entity in the second MEC system is an MEO entity of the second MEC system.

In Example 40, the subject matter of Example 39 includes subject matter where the instructions configure the hardware components to receive availability information for the MEC service from the MEO entity of the second MEC system via a second Mfm-fed MEC federation reference point.

In Example 41, the subject matter of any of Examples 37-40 includes subject matter where the request for the MEC service originates from the MEC application instantiated on the first MEC host and is received by the MEO entity from a MEC platform manager of the first MEC system via an Mm3 MEC reference point.

In Example 42, the subject matter of any of Examples 36-41 includes subject matter where the instructions configure the hardware components to encode the request for the MEC service for transmission to a second federation management system in the federated MEC network.

In Example 43, the subject matter of Example 42 includes subject matter where the second federation management system is a federation manager of the second MEC system.

In Example 44, the subject matter of any of Examples 42-43 includes subject matter where the instructions configure the hardware components to receive a notification from the second federation management system, the notification including identification information of one or more other MEC systems within the federated MEC network that offer the MEC service; and select the second MEC system from the one or more other MEC systems for providing the MEC service based on the notification.

In Example 45, the subject matter of Example 44 includes subject matter where the notification further includes identification information of Mobile Edge Orchestrator (MEO) entities associated with the one or more other MEC systems that provide the MEC service.

In Example 46, the subject matter of Example 45 includes subject matter where the MEC management entity in the second MEC system is one of the MEO entities identified in the notification, and wherein the identification information comprises an MEO identification (ID) of the MEO entity in the second MEC system.

In Example 47, the subject matter of any of Examples 42 46 includes subject matter where the instructions configure the hardware components to determine the set of common credentials via a communication exchange with the second federation management system.

In Example 48, the subject matter of Example 47 includes subject matter where the set of common credentials further includes service charging credentials and service monitoring credentials associated with accessing the MEC service in the second MEC system.

In Example 49, the subject matter of any of Examples 35-48 includes subject matter where the MEC service is a service-producing MEC application instantiated on the second MEC host.

In Example 50, the subject matter of any of Examples 35-49 includes subject matter where the MEC service is a service of a MEC platform of the second MEC host.

In Example 51, the subject matter of any of Examples 35-50 includes subject matter where the federation management system is a federation broker entity configured to manage communications between a federation management system of the first MEC system and a federation management system of the second MEC system.

Example 52 is a computing node implementing a Multi-Access Edge Computing (MEC) management entity associated with a federated MEC network, the node comprising: memory, and processing circuitry coupled to the memory, the processing circuitry configured to: decode a request for a MEC service, the request originating from a MEC application instantiated on a first MEC host within a first MEC system of the federated MEC network and received from a first MEC platform manager of the first MEC system, encode the request for the MEC service for re-transmission to a federation management entity of the federated MEC network via a Mfm-fed MEC federation reference point; and decode a response to the request, the response received from the federation management entity via the Mfm-fed MEC federation reference point and including a set of common credentials for communication with a second MEC system providing access to the MEC service and identification information of a second MEC management entity in the second MEC system; and perform a discovery operation with the second MEC management entity using the set of common credentials.

In Example 53, the subject matter of Example 52 includes subject matter where the processing circuitry is further configured to obtain, from the second MEC management entity, identification information of a second MEC host in the second MEC system, the second MEC host providing the MEC service.

In Example 54, the subject matter of Example 53 includes subject matter where the processing circuitry is further configured to encode the request for the MEC service for re-transmission to the second MEC host via the second MEC management entity.

In Example 55, the subject matter of Example 54 includes subject matter where the MEC management entity is a Mobile Edge Orchestrator (MEO) entity in the first MEC system, and the second MEC management entity is a second MEO entity in the second MEC system.

In Example 56, the subject matter of Example 55 includes subject matter where the processing circuitry is further configured to cause re-transmission of the request for the MEC service to the second MEO entity via a Meo-fed MEC federation reference point.

In Example 57, the subject matter of any of Examples 55-56 includes subject matter where the processing circuitry is further configured to cause re-transmission of the request for the MEC service to the second MEC host via the second MEO entity and a MEC platform manager of the second MEC host.

In Example 58, the subject matter of any of Examples 52-57 includes subject matter where the MEC service is hosted in a second MEC host in the second MEC system.

In Example 59, the subject matter of Example 58 includes subject matter where the MEC service is a service-producing MEC application instantiated on the second MEC host.

In Example 60, the subject matter of any of Examples 58-59 includes subject matter where the MEC service is a service of a MEC platform of the second MEC host.

In Example 61, the subject matter of Example 60 includes subject matter where the MEC service is accessed by the MEC application at least partially via an Mpp-fed MEC federation reference point between a MEC platform of the first MEC host and the MEC platform of the second MEC host.

Example 62 is at least one machine-readable storage medium comprising instructions stored thereupon, which when executed by processing circuitry of a computing node operable to implement a Multi-Access Edge Computing (MEC) management entity in a federated MEC network, cause the processing circuitry to perform operations comprising: decoding a request for a MEC service, the request originating from a MEC application instantiated on a first MEC host within a first MEC system of the federated MEC network and received from a first MEC platform manager of the first MEC system; encoding the request for the MEC service for re-transmission to a federation management entity of the federated MEC network via a Mfm-fed MEC federation reference point; and decoding a response to the request, the response received from the federation management entity via the Mfm-fed MEC federation reference point and including a set of common credentials for communication with a second MEC system providing access to the MEC service and identification information of a second MEC management entity in the second MEC system; and performing a discovery operation with the second MEC management entity using the set of common credentials.

In Example 63, the subject matter of Example 62 includes subject matter where executing the instructions further cause the processing circuitry to perform operations comprising: obtaining, from the second MEC management entity, identification information of a second MEC host in the second MEC system, the second MEC host providing the MEC service.

In Example 64, the subject matter of Example 63 includes subject matter where executing the instructions further cause the processing circuitry to perform operations comprising: encoding the request for the MEC service for re-transmission to the second MEC host via the second MEC management entity

In Example 65, the subject matter of Example 64 includes subject matter where the MEC management entity is a Mobile Edge Orchestrator (MEO) entity in the first MEC system, and the second MEC management entity is a second MEO entity in the second MEC system.

In Example 66, the subject matter of Example 65 includes subject matter where executing the instructions further cause the processing circuitry to perform operations comprising: causing re-transmission of the request for the MEC service to the second MEO entity via a Meo-fed MEC federation reference point.

In Example 67, the subject matter of any of Examples 65-66 includes subject matter where executing the instructions further cause the processing circuitry to perform operations comprising: causing re-transmission of the request for the MEC service to the second MEC host via the second MEO entity and a MEC platform manager of the second MEC host.

In Example 68, the subject matter of any of Examples 62-67 includes subject matter where the MEC service is hosted in a second MEC host in the second MEC system.

In Example 69, the subject matter of Example 68 includes subject matter where the MEC service is a service-producing MEC application instantiated on the second MEC host

In Example 70, the subject matter of any of Examples 68-69 includes subject matter where the MEC service is a service of a MEC platform of the second MEC host.

In Example 71, the subject matter of Example 70 includes subject matter where the MEC service is accessed by the MEC application at least partially via an Mpp-fed MEC federation reference point between a MEC platform of the first MEC host and the MEC platform of the second MEC host.

Example 72 is a Multi-Access Edge Computing (MEC) management system comprising: a plurality of hardware components, including a processing circuitry and network communications circuitry, and at least one memory device including instructions embodied thereon, wherein the instructions, which when executed by the processing circuitry, configure the hardware components to perform operations to: decode a request for a MEC service, the request originating from a MEC application instantiated on a first MEC host within a first MEC system of a federated MEC network and received from a first MEC platform manager of the first MEC system; encode the request for the MEC service for re-transmission to a federation management entity of the federated MEC network via a Mfm-fed MEC federation reference point, and decode a response to the request, the response received from the federation management entity via the Mfm-fed MEC federation reference point and including a set of common credentials for communication with a second MEC system providing access to the MEC service and identification information of a second MEC management entity in the second MEC system, and perform a discovery operation with the second MEC management entity using the set of common credentials.

In Example 73, the subject matter of Example 72 includes subject matter where the instructions configure the hardware components to obtain, from the second MEC management entity, identification information of a second MEC host in the second MEC system, the second MEC host providing the MEC service.

In Example 74, the subject matter of Example 73 includes subject matter where the instructions configure the hardware components to encode the request for the MEC service for re-transmission to the second MEC host via the second MEC management entity.

In Example 75, the subject matter of Example 74 includes subject matter where the MEC management entity is a Mobile Edge Orchestrator (MEO) entity in the first MEC system, and the second MEC management entity is a second MEO entity in the second MEC system.

In Example 76, the subject matter of Example 75 includes subject matter where the instructions configure the hardware components to cause re-transmission of the request for the MEC service to the second MEO entity via a Meo-fed MEC federation reference point.

In Example 77, the subject matter of any of Examples 75-76 includes subject matter where the instructions configure the hardware components to cause re-transmission of the request for the MEC service to the second MEC host via the second MEO entity and a MEC platform manager of the second MEC host.

In Example 78, the subject matter of any of Examples 72-77 includes subject matter where the MEC service is hosted in a second MEC host in the second MEC system.

In Example 79, the subject matter of Example 78 includes subject matter where the MEC service is a service-producing MEC application instantiated on the second MEC host.

In Example 80, the subject matter of any of Examples 78-79 includes subject matter where the MEC service is a service of a MEC platform of the second MEC host.

In Example 81, the subject matter of Example 80 includes subject matter where the MEC service is accessed by the MEC application at least partially via an Mpp-fed MEC federation reference point between a MEC platform of the first MEC host and the MEC platform of the second MEC host.

Example 82 is at least one machine-readable medium including instructions that, when executed by processing circuitry, cause the processing circuitry to perform operations to implement any of Examples 1-81.

Example 83 is an apparatus comprising means to implement any of Examples 1-81.

Example 84 is a system to implement any of Examples 1-81.

Example 85 is a method to implement any of Examples 1-81.

Example 86 is a multi-tier edge computing system, comprising a plurality of edge computing nodes provided among on-premise edge, network access edge, or near edge computing settings, the plurality of edge computing nodes configured to perform any of the methods of Examples 1-81.

Example 87 is an edge computing system, comprising a plurality of edge computing nodes, each of the plurality of edge computing nodes configured to perform any of the methods of Examples 1-81

Example 88 is an edge computing node, operable as a server hosting the service and a plurality of additional services in an edge computing system, configured to perform any of the methods of Examples 1-81.

Example 89 is an edge computing node, operable in a layer of an edge computing network as an aggregation node, network hub node, gateway node, or core data processing node, configured to perform any of the methods of Examples 1-81.

Example 90 is an edge provisioning, orchestration, or management node, operable in an edge computing system, configured to implement any of the methods of Examples 1-81.

Example 91 is an edge computing network, comprising networking and processing components configured to provide or operate a communications network, to enable an edge computing system to implement any of the methods of Examples 1-81.

Example 92 is an access point, comprising networking and processing components configured to provide or operate a communications network, to enable an edge computing system to implement any of the methods of Examples 1-81.

Example 93 is a base station, comprising networking and processing components configured to provide or operate a communications network, configured as an edge computing system to implement any of the methods of Examples 1-81.

Example 94 is a road-side unit, comprising networking components configured to provide or operate a communications network, configured as an edge computing system to implement any of the methods of Examples 1-81.

Example 95 is an on-premise server, operable in a private communications network distinct from a public edge computing network, configured as an edge computing system to implement any of the methods of Examples 1-81.

Example 96 is a 3GPP 4G/LTE mobile wireless communications system, comprising networking and processing components configured as an edge computing system to implement any of the methods of Examples 1-81.

Example 97 is a 5G network mobile wireless communications system, comprising networking and processing components configured as an edge computing system to implement any of the methods of Examples 1-81.

Example 98 is an edge computing system configured as an edge mesh, provided with a microservice cluster, a microservice cluster with sidecars, or linked microservice clusters with sidecars, configured to implement any of the methods of Examples 1-81.

Example 99 is an edge computing system, comprising circuitry configured to implement services with one or more isolation environments provided among dedicated hardware, virtual machines, containers, or virtual machines on containers, the edge computing system configured to implement any of the methods of Examples 1-81.

Example 100 is an edge computing system, comprising networking and processing components to communicate with a user equipment device, client computing device, provisioning device, or management device to implement any of the methods of Examples 1-81.

Example 101 is networking hardware with network functions implemented thereupon, operable within an edge computing system, the network functions configured to implement any of the methods of Examples 1-81.

Example 102 is acceleration hardware with acceleration functions implemented thereupon, operable in an edge computing system, the acceleration functions configured to implement any of the methods of Examples 1-81

Example 103 is storage hardware with storage capabilities implemented thereupon, operable in an edge computing system, the storage hardware configured to implement any of the methods of Examples 1-81

Example 104 is computation hardware with compute capabilities implemented thereupon, operable in an edge computing system, the computation hardware configured to implement any of the methods of Examples 1-81.

Example 105 is an edge computing system configured to implement services with any of the methods of Examples 1-81, with the services relating to one or more of: compute offload, data caching, video processing, network function virtualization, radio access network management, augmented reality, virtual reality, autonomous driving, vehicle assistance, vehicle communications, industrial automation, retail services, manufacturing operations, smart buildings, energy management, internet of things operations, object detection, speech recognition, healthcare applications, gaming applications, or accelerated content processing.

Example 106 is an apparatus of an edge computing system comprising: one or more processors and one or more computer-readable media comprising instructions that, when executed by the one or more processors, cause the one or more processors to perform any of the methods of Examples 1-81.

Example 107 is one or more computer-readable storage media comprising instructions to cause an electronic device of an edge computing system, upon execution of the instructions by one or more processors of the electronic device, to perform any of the methods of Examples 1-81.

Example 108 is a computer program used in an edge computing system, the computer program comprising instructions, wherein execution of the program by a processing element in the edge computing system is to cause the processing element to perform any of the methods of Examples 1-81.

Example 109 is an edge computing appliance device operating as a self-contained processing system, comprising a housing, case, or shell, network communication circuitry, storage memory circuitry, and processor circuitry adapted to perform any of the methods of Examples 1-81.

Example 110 is an apparatus of an edge computing system comprising means to perform any of the methods of Examples 1-81.

Example 111 is an apparatus of an edge computing system comprising logic, modules, or circuitry to perform any of the methods of Examples 1-81.

Example 112 is an edge computing system, including respective edge processing devices and nodes to invoke or perform any of the operations of Examples 1-81, or other subject matter described herein.

Example 113 is a client endpoint node, operable to invoke or perform the operations of any of Examples 1-81, or other subject matter described herein.

Example 114 is an aggregation node, network hub node, gateway node, or core data processing node, within or coupled to an edge computing system, operable to invoke or perform the operations of any of Examples 1-81, or other subject matter described herein.

Example 115 is an access point, base station, road-side unit, street-side unit, or on-premise unit, within or coupled to an edge computing system, operable to invoke or perform the operations of any of Examples 1-81, or other subject matter described herein.

Example 116 is an edge provisioning node, service orchestration node, application orchestration node, or multi-tenant management node, within or coupled to an edge computing system, operable to invoke or perform the operations of any of Examples 1-81, or other subject matter described herein.

Example 117 is an edge node operating an edge provisioning service, application or service orchestration service, virtual machine deployment, container deployment, function deployment, and compute management, within or coupled to an edge computing system, operable to invoke or perform the operations of any of Examples 1-81, or other subject matter described herein.

Example 118 is an edge computing system including aspects of network functions, acceleration functions, acceleration hardware, storage hardware, or computation hardware resources, operable to invoke or perform the use cases discussed herein, with use of any Examples 1-81, or other subject matter described herein.

Example 119 is an edge computing system adapted for supporting client mobility, vehicle-to-vehicle (V2V), vehicle-to-everything (V2X), or vehicle-to-infrastructure (V2I) scenarios, and optionally operating according to European Telecommunications Standards Institute (ETSI) Multi-Access Edge Computing (MEC) specifications, operable to invoke or perform the use cases discussed herein, with use of any of Examples 1-81, or other subject matter described herein.

Example 120 is an edge computing system adapted for mobile wireless communications, including configurations according to a 3GPP 4G/LTE or 5G network capabilities, operable to invoke or perform the use cases discussed herein, with use of any of Examples 1-81, or other subject matter described herein.

Example 121 is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of any of Examples 1-81, or other subject matter described herein.

Example 122 is networking hardware, acceleration hardware, storage hardware, or computation hardware, with capabilities implemented thereupon, operable in an edge computing system to invoke or perform the use cases discussed herein, with use of any of Examples 1-81, or other subject matter described herein.

Example 123 is an apparatus of an edge computing system comprising: one or more processors and one or more computer-readable media comprising instructions that, when deployed and executed by the one or more processors, cause the one or more processors to invoke or perform the use cases discussed herein, with use of any of Examples 1-81, or other subject matter described herein.

Example 124 is one or more computer-readable storage media comprising instructions to cause an electronic device of an edge computing system, upon execution of the instructions by one or more processors of the electronic device, to invoke or perform the use cases discussed herein, with the use of any of Examples 1-81, or other subject matter described herein.

Example 125 is an apparatus of an edge computing system comprising means, logic, modules, or circuitry to invoke or perform the use cases discussed herein, with the use of any of Examples 1-81, or other subject matter described herein.

Although these implementations have been described with reference to specific exemplary aspects, it will be evident that various modifications and changes may be made to these aspects without departing from the broader scope of the present disclosure. Many of the arrangements and processes described herein can be used in combination or parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is disclosed. Thus, although specific aspects have been illustrated and described herein, it should be appreciated that any arrangement calculated to achieve the same purpose may be substituted for the specific aspects shown. This disclosure is intended to cover any adaptations or variations of various aspects. Combinations of the above aspects and other aspects not specifically described herein will be apparent to those of skill in the art upon reviewing the above description.

1-25. (canceled)

26. A computing node to implement a federation management entity associated with a federated Multi-Access Edge Computing (MEC) network, the node comprising:
a network interface card (NIC); and
processing circuitry coupled to the NIC, the processing circuitry configured to:
detect a request for a MEC service, the request originating from a MEC application instantiated on a first MEC host within a first MEC system of the federated MEC network;
select a second MEC system of the federated MEC network, the second MEC system including a second MEC host providing the MEC service;
determine a set of common credentials for secure communication between the first MEC system and the second MEC system; and
generate a response to the request for communication to the first MEC system via the NIC, the response including the set of common credentials and identification information of a MEC management entity in the second MEC system, the MEC management entity in the second MEC system providing access to the MEC service.

27. The node of claim 26, wherein the federation management entity is a federation manager of the first MEC system.

28. The node of claim 27, wherein the processing circuitry is configured to:
receive the request for the MEC service from a MEC orchestrator (MEO) entity of the first MEC system via a first Mfm-fed MEC federation reference point.

29. The node of claim 28, wherein the federation management entity is a common federation manager of the first MEC system and the second MEC system.

30. The node of claim 29, wherein the MEC management entity in the second MEC system is a MEO entity of the second MEC system.

31. The node of claim 30, wherein the processing circuitry is configured to:
receive availability information for the MEC service from the MEO entity of the second MEC system via a second Mfm-fed MEC federation reference point.

32. The node of claim 28, wherein the request for the MEC service originates from the MEC application instantiated on the first MEC host and is received by the MEO entity from a MEC platform manager of the first MEC system via a Mm3 MEC reference point.

33. The node of claim 27, wherein the processing circuitry is configured to:
encode the request for the MEC service for transmission to a second federation management entity in the federated MEC network.

34. The node of claim 33, wherein the second federation management entity is a federation manager of the second MEC system.

35. The node of claim 33, wherein the processing circuitry is configured to:
receive a notification from the second federation management entity, the notification including identification information of one or more other MEC systems within the federated MEC network that offer the MEC service; and
select the second MEC system from the one or more other MEC systems for providing the MEC service based on the notification.

36. The node of claim 35, wherein the notification further includes identification information of MEC orchestrator (MEO) entities associated with the one or more other MEC systems that provide the MEC service.

37. The node of claim 36, wherein the MEC management entity in the second MEC system is one of the MEO entities identified in the notification, and wherein the identification information comprises a MEO identification (ID) of the MEO entity in the second MEC system.

38. The node of claim 33, wherein the processing circuitry is configured to:
determine the set of common credentials via a communication exchange with the second federation management entity.

39. The node of claim 38, wherein the set of common credentials further includes service charging credentials and service monitoring credentials associated with accessing the MEC service in the second MEC system.

40. At least one non-transitory machine-readable storage medium comprising instructions stored thereupon, which when executed by processing circuitry of a computing node operable to implement a federation management entity in a federated Multi-Access Edge Computing (MEC) network, cause the processing circuitry to perform operations comprising:
detecting a request for a MEC service, the request originating from a MEC application instantiated on a first MEC host within a first MEC system of the federated MEC network;
selecting a second MEC system of the federated MEC network, the second MEC system including a second MEC host providing the MEC service;
determining a set of common credentials for secure communication between the first MEC system and the second MEC system; and
generating a response to the request for communication to the first MEC system, the response including the set of common credentials and identification information of a MEC management entity in the second MEC system, the MEC management entity in the second MEC system providing access to the MEC service.

41. The machine-readable storage medium of claim 40, wherein the federation management entity is a federation manager of the first MEC system.

42. The machine-readable storage medium of claim 41, wherein executing the instructions further cause the processing circuitry to perform operations comprising:
receiving the request for the MEC service from a MEC orchestrator (MEO) entity of the first MEC system via a first Mfm-fed MEC federation reference point.

43. The machine-readable storage medium of claim 42, wherein the federation management entity is a common federation manager of the first MEC system and the second MEC system.

44. The machine-readable storage medium of claim 43, wherein the MEC management entity in the second MEC system is a MEO entity of the second MEC system.

45. The machine-readable storage medium of claim 44, wherein executing the instructions further cause the processing circuitry to perform operations comprising:
receiving availability information for the MEC service from the MEO entity of the second MEC system via a second Mfm-fed MEC federation reference point.

46. The machine-readable storage medium of claim 42, wherein the request for the MEC service originates from the MEC application instantiated on the first MEC host and is received by the MEO entity from a MEC platform manager of the first MEC system via a Mm3 MEC reference point.

47. A federation management system comprising:
a plurality of hardware components, including a processing circuitry and network communications circuitry; and
at least one memory device including instructions embodied thereon, wherein the instructions, which when executed by the processing circuitry, configure the hardware components to perform operations to:
detect a request for a Multi-Access Edge Computing (MEC) service, the request originating from a MEC application instantiated on a first MEC host within a first MEC system of a federated MEC network;
select a second MEC system of the federated MEC network, the second MEC system including a second MEC host providing the MEC service;
determine a set of common credentials for secure communication between the first MEC system and the second MEC system; and
generate a response to the request for communication to the first MEC system via the network communications circuitry, the response including the set of common credentials and identification information of a MEC management entity in the second MEC system, the MEC management entity in the second MEC system providing access to the MEC service.

48. The system of claim 47, wherein the federation management system is a federation manager of the first MEC system.

49. The system of claim 48, wherein the instructions configure the hardware components to:
receive the request for the MEC service from a MEC orchestrator (MEO) entity of the first MEC system via a first Mfm-fed MEC federation reference point.

50. The system of claim 48, wherein the instructions configure the hardware components to:
encode the request for the MEC service for transmission to a second federation management system in the federated MEC network.
